(19) United States
(12) Patent Application Publication
(10) Pub. No.: US 2010/0330437 A1
(43) Pub. Date: Dec. 30, 2010

(54) METAL-AIR FLOW CELL

(75) Inventors: Trygve Burchardt, Mannedorf (CH); James P. McDougall, Mannedorf (CH); Romuald Franklin Ngamga, Mannedorf (CH); Heinz Studiger, Zurich (CH); Wade Guindy, Henderson, NV (US)

Correspondence Address: FOLEY & LARDNER LLP, 777 EAST WISCONSIN AVENUE, MILWAUKEE, WI, 53202-5306, US

(73) Assignee: ReVolt Technology Ltd.

(21) Appl. No.: 12/826,383

(22) Filed: Jun. 29, 2010

Related U.S. Application Data
(60) Provisional application No. 61/221,998, filed on Jun. 30, 2009.
(60) Provisional application No. 61/340,293, filed on Mar. 15, 2010.

(51) Int. Cl. H01M 12/06

(52) U.S. Cl. 429/406; 429/405

(57) ABSTRACT

A metal-air flow battery is provided that comprises a tank configured to contain an anode paste material; a reaction tube in fluid communication with the tank, the reaction tube comprising an air electrode, an outer surface configured to allow air to enter the reaction tube, and an internal passage; and a mechanism for moving the anode paste material through the internal passage of the reaction tube.

### CROSS-REFERENCE TO RELATED PATENT APPLICATIONS

The present application claims priority to and the benefit of U.S. Provisional Patent Application No. 61/221,998, filed Jun. 30, 2009, and U.S. Provisional Patent Application No. 61/340,293, filed Mar. 15, 2010, the entire disclosures of which are incorporated herein by reference.

### BACKGROUND

The present application relates generally to the field of batteries. More specifically, the present application relates to secondary (i.e., rechargeable) batteries and battery systems, and in particular to metal-air batteries and battery systems.

Metal-air batteries include a negative metal electrode (e.g., zinc, aluminum, magnesium, iron, lithium, etc.) and a positive electrode having a porous structure with catalytic properties for an oxygen reaction (typically referred to as the air electrode for the battery). An electrolyte is used to maintain high ionic conductivity between the two electrodes. For alkaline metal-air batteries (i.e., having an alkaline electrolyte), the air electrode is usually made from thin, porous polymeric material (e.g., polytetrafluoroethylene) bonded carbon layers. To prevent a short circuit of the battery, a separator is provided between the anode and the cathode.

During discharging of the metal-air batteries, oxygen from the atmosphere is converted to hydroxyl ions in the air electrode. The reaction in the air electrode involves the reduction of oxygen, the consumption of electrons, and the production of hydroxyl ions. The hydroxyl ions migrate through the electrolyte towards the metal-negative electrode, where oxidation of the metal of the negative electrode occurs, forming oxides and liberating electrons. In a secondary (i.e., rechargeable) metal-air battery, charging converts hydroxyl ions to oxygen in the air electrode, releasing electrons. At the metal electrode, the metal oxides or ions are reduced to form the metal while electrons are consumed.

Metal-air batteries provide significant energy capacity benefits. For example, metal-air batteries have several times the energy storage density of lithium-ion batteries, while using globally abundant and low-cost metals (e.g., zinc) as the energy storage medium. The technology is relatively safe (non-flammable) and environmentally friendly (non-toxic and recyclable materials may be used). Since the technology uses materials and processes that are readily available in the U.S. and elsewhere, dependence on scarce resources such as oil may be reduced.

Along with the increased use of renewable energy sources comes the need for on-grid energy storage and conversion for peak shaving, load leveling, and backup power. For such applications, competing secondary battery technologies (e.g., lithium ion (Li-Ion), nickel-metal-hydride (NiMH), etc.) provide insufficient energy density to be practically and efficiently utilized. For example, the efficiency of the U.S. utility sector, which currently faces high costs because of intermittent power generation profiles, could be improved with on-grid energy storage and conversion for peak shaving, load leveling, and back-up power. For electric vehicle and hybrid electric vehicle applications, traditional nickel cadmium (Ni—Cd), NiMH, and Li-Ion batteries may not be ideally suited to provide desired performance characteristics (e.g., life, power, etc.). Also, traditional secondary battery technologies are typically expensive and may utilize component materials that are limited in their availability.

It would be advantageous to provide an improved battery and/or battery system that addresses one or more of the foregoing issues. It would also be advantageous to provide a metal-air battery and battery system that may be used in a variety of applications, including, but not limited to, automotive applications and providing storage for on-grid energy storage and conversion for peak shaving, load leveling, and back-up power. Other advantageous features of the system disclosed herein will be apparent to those reviewing the present disclosure.

### SUMMARY

An exemplary embodiment relates to a metal-air flow battery that comprises a tank configured to contain an anode paste material; a reaction tube in fluid communication with the tank, the reaction tube comprising an air electrode, an outer surface configured to allow air to enter the reaction tube, and an internal passage; and a mechanism for moving the anode paste material through the internal passage of the reaction tube.

Another exemplary embodiment relates to a metal-air flow battery that comprises a tank configured to contain an anode paste material that comprises a metal and an electrolyte; a plurality of reaction tubes in fluid communication with the tank, the reaction tubes each comprising an air electrode, an outer surface configured to allow air to enter the reaction tube, and an internal passage through which the anode paste material may be directed; and a plurality of screws driven by a motor, each of the plurality of screws extending through an internal passage of an associated one of the reaction tubes, wherein the screws are configured to move the anode paste material through the reaction tubes.

Another exemplary embodiment relates to a metal-air flow battery comprising a storage tank configured to contain an anode paste; a plurality of reaction tubes coupled to the storage tank, the reaction tubes each comprising an air electrode, wherein the metal-air flow battery is configured to move the anode paste through the reaction tubes during charging and discharging to reversibly convert the anode paste between a metal anode paste and a metal-oxide anode paste.

### BRIEF DESCRIPTION OF THE DRAWINGS

FIG. 1 is a perspective view of a vehicle utilizing a metal-air flow battery according to an exemplary embodiment.

FIG. 2 is perspective view of a metal-air flow battery according to an exemplary embodiment.

FIG. 3 is an exploded view the metal-air flow battery shown in FIG. 2.

FIG. 4 is a cross-sectional view of the metal-air flow battery shown in FIG. 2.

FIG. 5 is a side view of the metal-air flow battery shown in FIG. 2.

FIG. 6 is a perspective view of a reaction tube and a portion of the feed system of the metal-air flow battery shown in FIG. 2.

FIG. 7 is a partial perspective, cross-sectional view of the reaction tube and feed system shown in FIG. 6.

FIG. 8 is a partial perspective, cross-sectional view of the reaction tube and feed system shown in FIG. 6 as it would appear when the metal-air flow battery is in operation.

FIG. 9 is a partial side, plan, cross-sectional view of the reaction tube and feed system shown in FIG. 6 illustrating the removal of nucleated gases from the reaction tube during operation.

FIG. 10 is a cross-sectional view of the metal-air flow battery shown in FIG. 2 during discharge.

FIG. 11 is another cross-sectional view of the metal-air flow battery shown in FIG. 2 during discharge.

FIG. 12 is a cross-sectional view of the metal-air flow battery shown in FIG. 2 during charging.

FIG. 13 is another cross-sectional view of the metal-air flow battery shown in FIG. 2 during charging.

FIG. 14 is a cross-sectional view of another exemplary embodiment of a metal-air flow battery.

FIG. 15 is a partial perspective, cross-sectional view of another exemplary embodiment of a reaction tube and feed system for a metal-air flow battery as it would appear when the metal-air flow battery is in operation.

FIG. 16 is a perspective view of a portion of another exemplary embodiment of a reaction tube for a metal-air flow battery.

FIG. 17 is a diagram illustrating a metal-air flow battery according to an exemplary embodiment utilized in an energy grid application.

### DETAILED DESCRIPTION

As used herein, the term “flow battery” is intended to refer to a battery system in which reactants are transported into and out of the battery. For a metal-air flow battery system, this implies that the metal anode material and the electrolyte are introduced (e.g., pumped) into the battery and a metal oxide is removed from or taken out of the battery system. Like a fuel cell, the flow battery system requires a flow of reactants through the system during use.

According to an exemplary embodiment, a rechargeable metal-air flow battery is configured to provide energy storage and conversion, and may be used singularly or in combination and may be integrated into or with various systems and/or devices to improve efficiency, address energy demands, etc. Further, rechargeable metal-air flow batteries may be used in a wide range of applications having different energy conversion and/or storage needs, including, but not limited to, very large scale applications (e.g., utilities, functioning as a green energy source for a smart grid, energy storage for use in combination with renewable energy resources such as wind and solar power, etc.) and smaller applications (e.g., individual consumables such as vehicles, backup power, residential power, etc.).

Referring generally to the FIGURES, a metal-air flow battery shown as a zinc-air flow battery 10 is illustrated according to an exemplary embodiment, and is configured to act as an energy storage and conversion system. Although referred to herein as a zinc-air flow battery, it should be understood that other metal-air combinations may be used. For example, aluminum, magnesium, iron, or lithium may be used either in place of or in addition to zinc.

The zinc-air flow battery 10 is a secondary or rechargeable battery (e.g., it is configured to be reversibly charged and discharged), and has improved energy efficiency and lower energy-related emissions as compared to other types of energy systems. The zinc-air flow battery 10 may be used individually, in a modular zinc-air flow battery system, or in combination with other energy technologies (e.g., in hybrid car battery units, etc.). Unlike other secondary battery technologies, the energy density of the zinc-air flow battery 10 is not limited by the amount of reactants that can be stored internally within the battery.

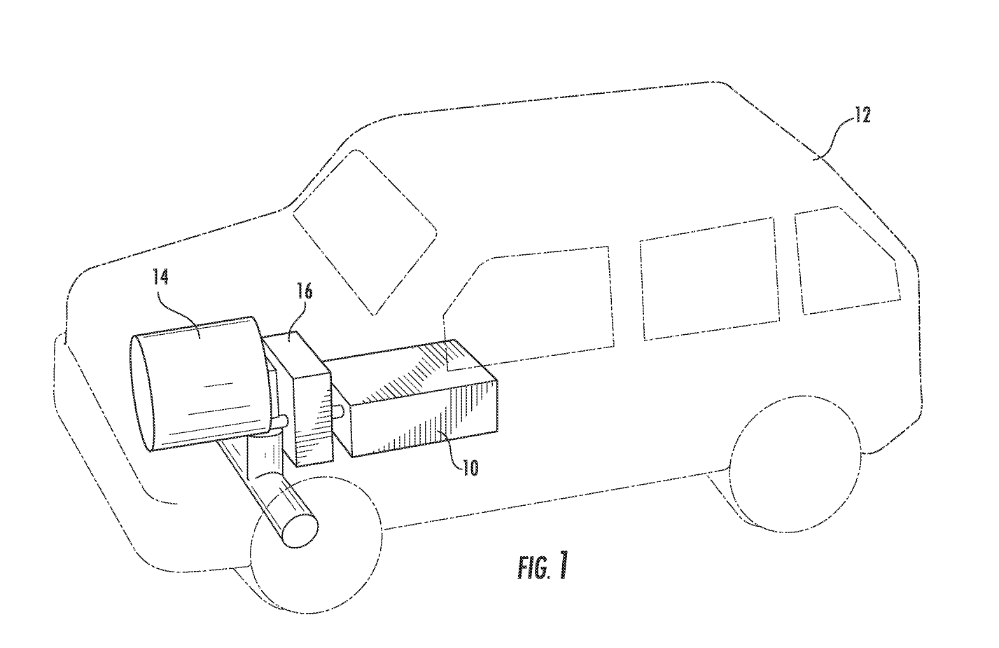

Referring to FIG. 1, the zinc-air flow battery 10 is shown utilized in a vehicle 12 to provide power to and, more generally, to operate the vehicle 12 according to an exemplary embodiment. The zinc-air flow battery 10 is shown coupled to an electrical drive train 14 and a control system 16 (which may be configured to control only the zinc-air flow battery or both the zinc-air flow battery and other features or systems within the vehicle 12). In the exemplary embodiment shown, the zinc-air flow battery 10 is intended to function as the primary motive power source for the vehicle 12; however, according to other exemplary embodiments, one or more metal-air flow batteries may be utilized in combination with one or more other power sources and/or power storage solutions (e.g., a high-powered battery, a super capacitor, a gasoline-powered engine or generator, etc.) to provide power to a vehicle. While the vehicle 12 is shown as a car, it should be noted that the vehicle may be any device configured to transport people and/or cargo (e.g., a dump truck, a motorcycle, a van, a semi-trailer truck, golf cart, forklift, and other types of vehicles now known or later developed, etc.).

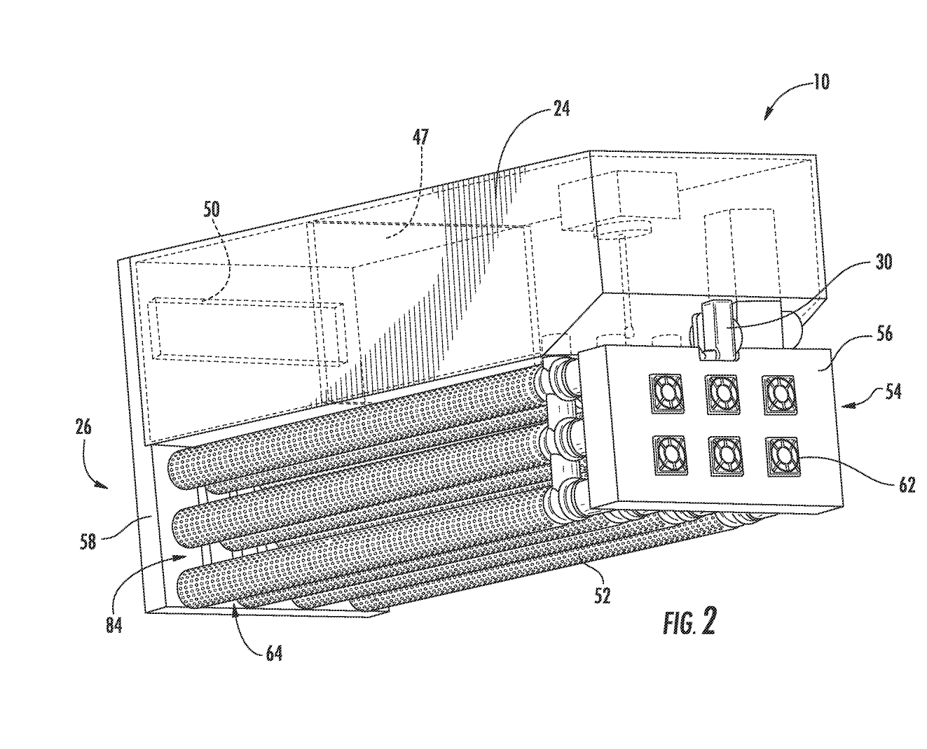

Referring to FIGS. 2-4, the zinc-air flow battery 10 is shown as a closed loop system including a zinc electrode 20, an electrolyte 22, one or more storage devices shown as a tank 24 (e.g., a container), a reactor 26 having reaction tubes 52, each reaction tube 52 including an air electrode 28, and a power input/output device 30.

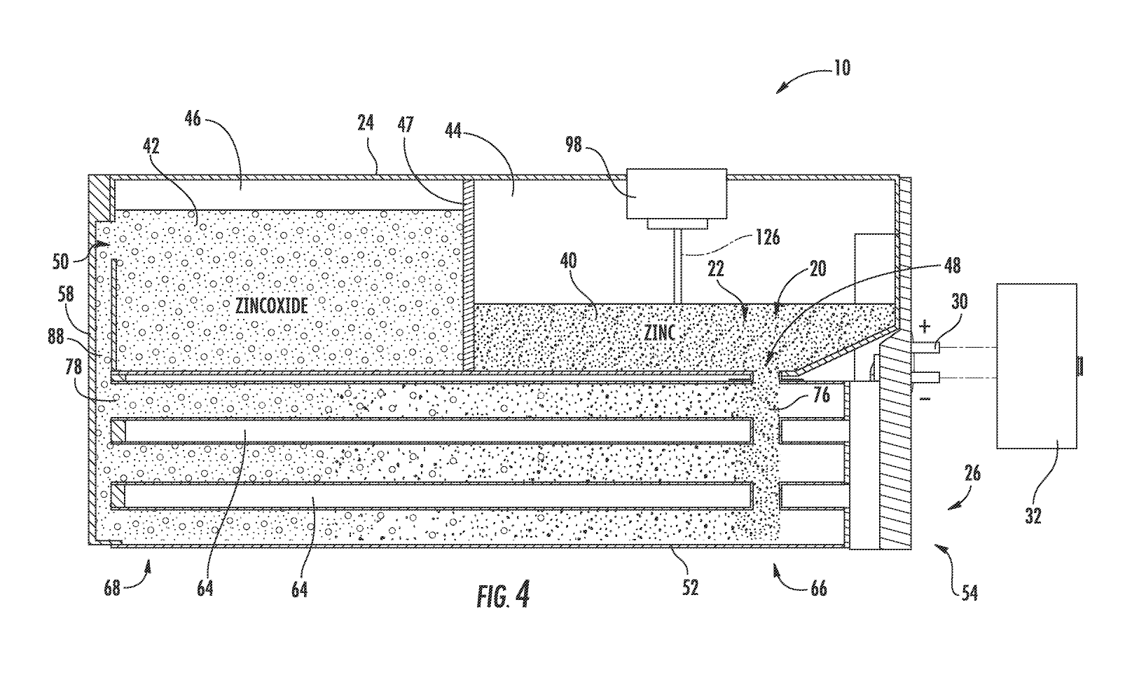

The power input/output device 30 is configured to provide for electrical integration of one or more zinc-air flow batteries 10 with one or more systems and/or devices to provide for energy conversion and storage for those systems and/or devices according to an exemplary embodiment. The power input/output device 30 is electrically coupled to the reactor 26, as will be discussed in more detail below. When the zinc-air flow battery 10 is discharging, the power input/output device 30 of the zinc-air flow battery 10 is also electrically coupled to the one or more systems and/or devices for which the zinc-air flow battery 10 is providing power (here, the vehicle 12), thereby electrically coupling the reactor 26 of the zinc-air flow battery 10 to the vehicle 12. When the zinc-air flow battery 10 is charging, the power input/output device 30 is coupled a charger 32 (e.g., a DC charger such as that shown uncoupled from the zinc-air flow battery 10 in FIG. 4). It should be noted that the power input/output device may have any of a variety of configurations depending on the intended application or other criteria.

The zinc electrode 20 and the electrolyte 22 (e.g., potassium hydroxide (KOH) or other hydroxyl ion (OH⁻) sources) are combined (e.g., mixed, stirred, etc.) to form an anode paste material, shown as zinc paste 40, which serves as a reactant for the zinc-air flow battery 10 according to an exemplary embodiment. The reactant (e.g., active material, etc.) is configured to be transported (e.g., fed, pumped, pushed, forced, etc.) into and out of the reactor 26. When the zinc-air flow battery 10 is discharging, the zinc paste 40 is transported into the reactor 26 and a zinc oxide paste 42 is transported out of the reactor 26 after the zinc paste 40 reacts with the hydroxyl ions produced when the air electrode 28 reacts with oxygen from the air. When the zinc-air flow battery 10 is charging, the zinc oxide paste 42 is transported into the reactor 26 and the zinc paste 40 is transported out of the reactor 26 after the hydroxyl ions are converted back to oxygen. According to other exemplary embodiments, the zinc electrode and the electrolyte may be combined in the form of a slurry, a pellet, or other form known in the art.

According to some exemplary embodiments, the electrolyte 22 is an alkaline electrolyte used to maintain high ionic conductivity between the metal and air electrodes. According to other exemplary embodiments, the electrolyte 22 may be any electrolyte that has high ionic conductivity and/or high reaction rates for the oxygen reduction/evolution and the metal oxidation/reduction reactions (e.g., ionic liquids, etc.). According to still other exemplary embodiments, the electrolyte may include salt water (e.g., for marine/military applications, etc.).

As will be discussed in more detail below, the composition of the zinc paste 40 and/or the zinc oxide paste 42 may be configured to achieve desirable flow characteristics and capacity characteristics of the zinc-air flow battery 10.

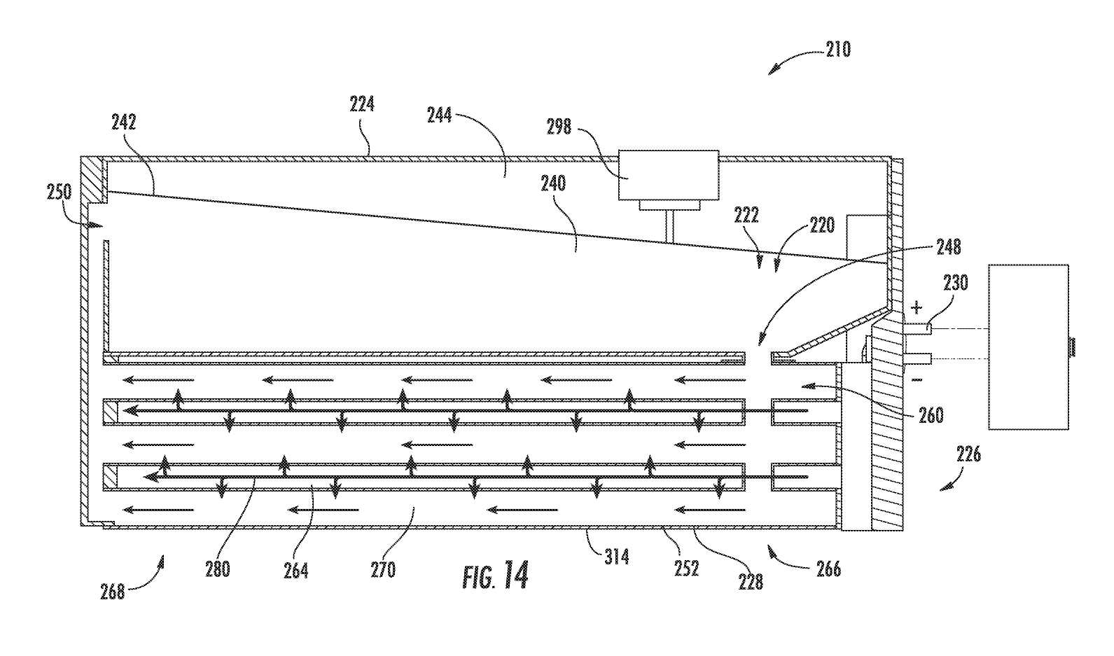

Referring to FIG. 4, the tank 24 is shown according to an exemplary embodiment as including a first cavity 44, shown as zinc or zinc paste cavity, separated from a second cavity 46, shown as zinc oxide or zinc oxide paste cavity, by a divider or partition 47. The tank 24 (depository, receptacle, container, bin, vessel, basin, tub, reservoir, etc.) is shown generally external to the reactor 26 and is configured to provide for storage of the anode materials, i.e., the zinc paste 40 and/or the zinc oxide paste 42, in the zinc-air flow battery 10. A zinc inlet/outlet 48 in the tank 24 provides for the zinc paste 40 to enter and exit the first cavity 44 (e.g., chamber, etc.). A zinc oxide inlet/outlet 50 in the tank 24 provides for the zinc oxide paste 42 to enter and exit the second cavity 46 (e.g., chamber, etc.). As shown in FIG. 4, both the zinc inlet/outlet 48 and the zinc oxide inlet/outlet 50 are in fluid communication with the reactor 26 such that the zinc and/or zinc oxide paste 40, 42 may be transported into and out of the reactor 26 during operation of the zinc-air flow battery 10. While the zinc-air flow battery is shown including a single tank segmented into two cavities, the zinc may be stored in a separate, independent tank (e.g., in two separate tanks) according to other exemplary embodiments. According to some exemplary embodiments, multiple tanks, zinc cavities, and/or multiple zinc oxide cavities may be utilized with a single reactor. Further, tanks may be interchanged (e.g., to adjust the power and storage capabilities of the zinc-air flow battery). According to other exemplary embodiments, the system can include only a single tank without two separate cavities, as will be describe below with respect to FIG. 14.

Referring to FIGS. 2-4, the tank 24 is shown as a generally closed container. Stated otherwise, the pastes 40, 42 are substantially not exposed to the environment outside the zinc-air flow battery 10 when stored in the tank 24. By preventing the pastes 40, 42 from being exposed to the environment, a number of problems can be avoided or minimized. These problems include, but are not limited to, corrosion, flooding, leakage, etc.

Referring further to FIGS. 2-4, the tank 24 is further configured to be modular, replaceable, and scalable independent of the reactor 26. As mentioned above, the energy density of the zinc-air flow battery 10 is not limited by the amount of reactants that can be stored internally. Instead, increasing the volume of the reactants in a tank generally increases the energy that a zinc-air flow battery is able to provide. Accordingly, it is generally the case that the greater the volume of the tank 24, the more power and energy the zinc-air flow battery 10 is able to provide. In some exemplary embodiments, a reactor of a zinc-air flow battery may be coupled to multiple tanks, thereby providing for increased reactant storage capacity. Generally, the tanks may be disposed adjacent to the reactor, as shown in the FIGURES, or the tanks may be located at a distance from the reactor (e.g., multiple feet, yards, etc.).

According to an exemplary embodiment, the tank 24 is made of a plastic material (e.g., polypropylene, polyethylene, etc.) or a plastic-coated material (e.g., a plastic-coated, steel tank) to substantially avoid corrosion of the zinc due to galvanic coupling. According to other exemplary embodiments, the tank may be made of any material that substantially avoids corrosion (e.g., copper, copper coated with zinc, copper coated with indium, etc.).

According to an exemplary embodiment, the tanks and/or cavities therein may be provided with one or more mixing devices configured to mix (e.g., stir, move, blend, etc.) the contents stored therein (e.g., the zinc paste, etc.) in order to maintain the homogeneity of the contents. Keeping the contents homogenous provides performance benefits. For example, keeping the contents homogenous typically improves the capacity of the zinc-air flow battery, because homogenous pastes are less likely to have areas that are too dry (e.g., resulting in passive film formulation) or too wet (e.g., resulting in low particle-to-particle contact).

Referring to FIGS. 2-6, the reactor 26 includes a plurality of reaction conduits, shown as reaction tubes 52, a support structure 54 including a first wall 56 substantially opposite a second wall 58, a distribution or feed system 60, and a device for directing a flow of air adjacent the outer surface of the reaction tubes 52, shown as a plurality of fans 62 according to an exemplary embodiment. The reactor 26 is fluidly coupled to the tank 24. As will be discussed in more detail below, the anode materials stored in the tank 24 are transported through the reactor 26 to generate power.

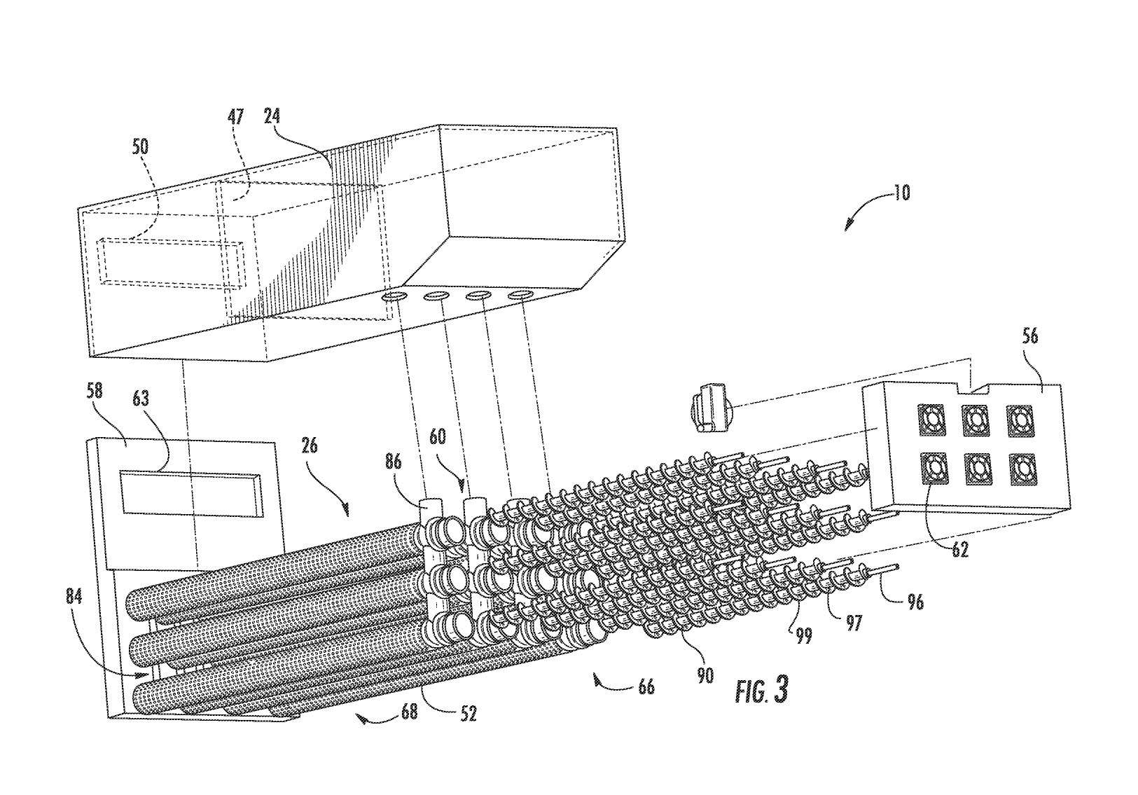

Referring to FIG. 2, the reaction tubes 52 are shown supported by the support structure 54, extending at least partially between the first wall 56 and the second wall 58, and are spaced apart to at least partially define a plurality of air flow channels 64 according to an exemplary embodiment. A first end portion 66 of each reaction tube 52 is shown disposed proximate to the first wall 56 coupled to the zinc inlet/outlet 48. A second end portion 68 of each reaction tube 52 is shown disposed proximate to the second wall 58 and coupled to the zinc oxide inlet/outlet 50. The reaction tubes 52 are coupled to the walls 56, 58 in a manner that provides for ease of maintenance and replacement. Further, the tank 24 is positioned substantially adjacent to the second wall 58 such that the zinc oxide inlet/outlet 50 of the tank 24 is substantially aligned with a corresponding zinc-oxide inlet/outlet 63, fluidly coupling the reaction tubes 52 and second cavity 46 of the tank 24 (see, e.g., FIG. 3 illustrating zinc-oxide inlet outlet 63 of the reactor 26). Stated otherwise, the tank 24 is in fluid communication with the reaction tubes 52. It should be noted that the reaction tubes may be disposed within the reactor in any number of orientations and/or arrangements. It should also be noted that a zinc-air flow battery may use substantially any number of reaction tubes (e.g., a single reaction tube, ten reaction tubes, thirty reaction tubes, etc.) having any desired size or configuration.

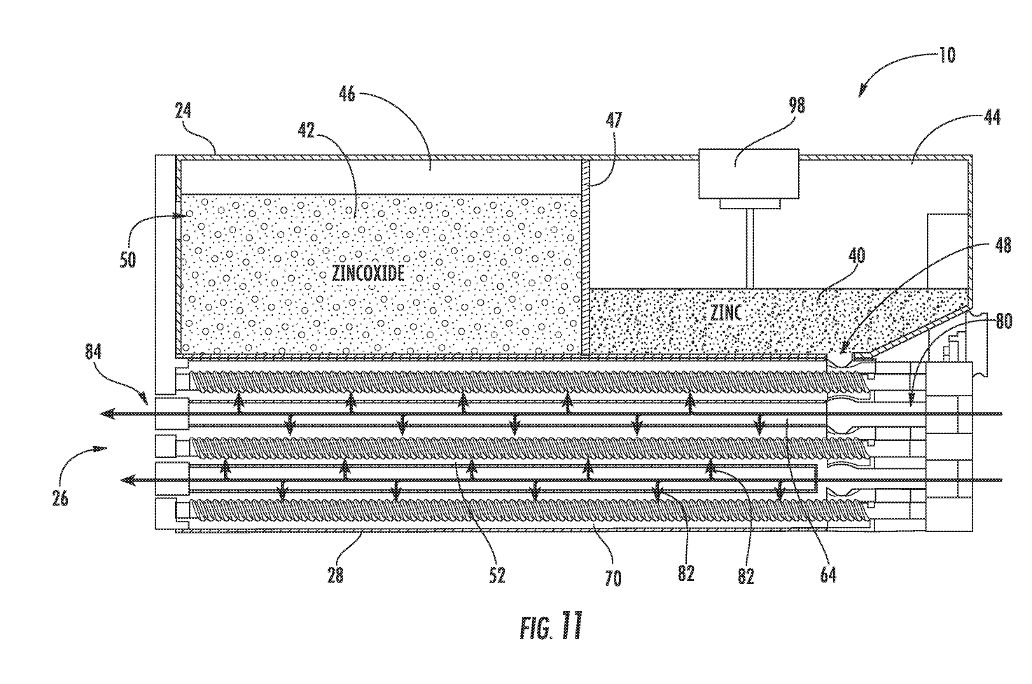

Referring to FIGS. 2-5, the reaction tubes 52 are configured to facilitate the discharging and charging of the zinc-air flow battery 10. Each reaction tube 52 includes a cathode material, shown as one or more layers of an air electrode 28. An internal passage 70 (see, e.g., FIG. 11) of each reaction tube 52 is configured to receive and allow for transport of anode material, here, the zinc paste 40 and the zinc oxide paste 42. As will be discussed in more detail below, oxygen is provided to the air electrodes 28 by the fans 62 and the zinc paste 40 and zinc oxide paste 42 are transported (e.g., fed, moved, driven, etc.) through the reaction tubes 52 by the feed system 60. As the zinc paste 40 is transported through the reaction tubes 52, the zinc-air flow battery 10 discharges. As the zinc oxide paste 42 is transported through the reaction tubes 52, the zinc-air flow battery 10 charges.

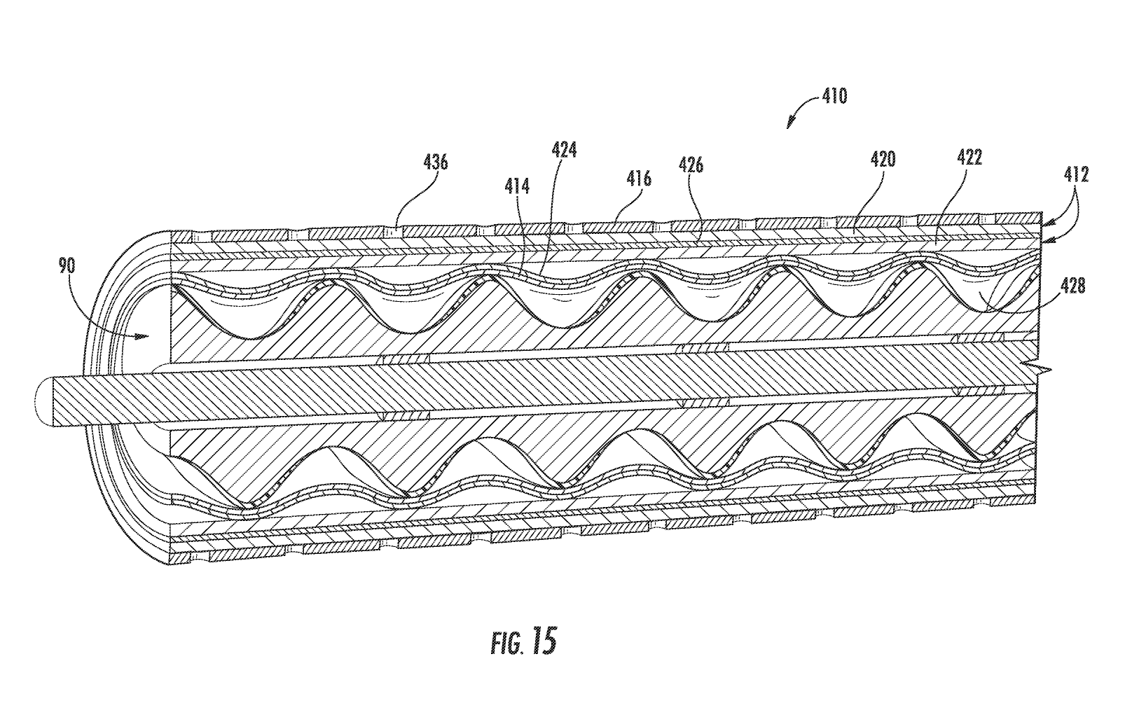

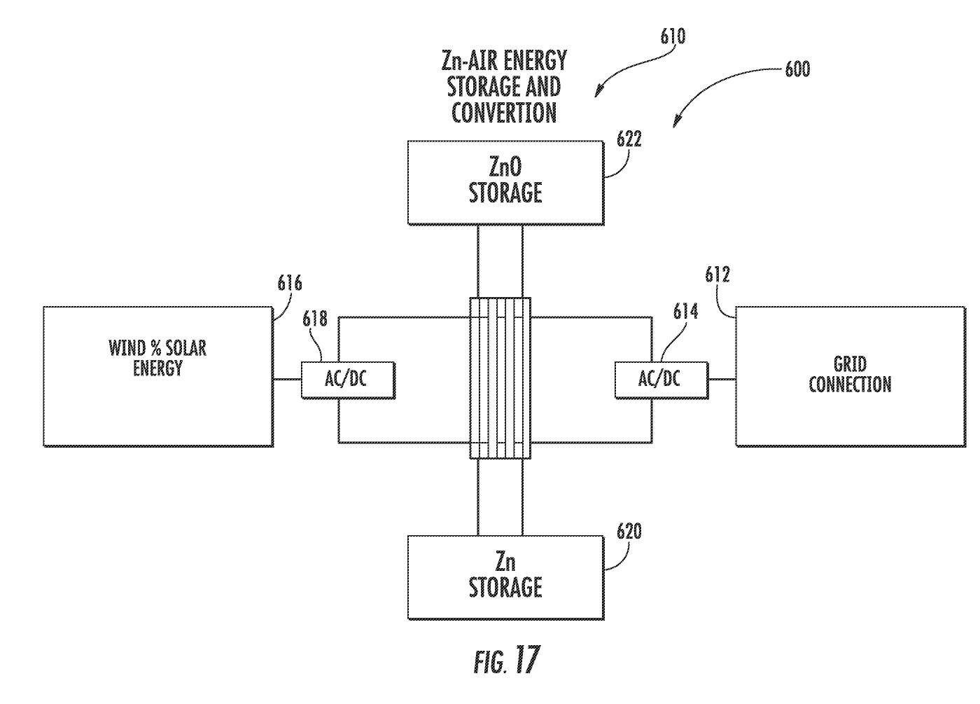

Referring to FIG. 2, the fans 62 provide an air flow 80 (see, e.g., FIGS. 15 and 17 illustrating the air flow 80) through the reactor 26 according to an exemplary embodiment. The air flow 80 provides oxygen to the air electrodes 28 of the reaction tubes 52, allowing for the oxygen reduction reaction. The air flow 80 passes adjacent the outer surfaces of the reaction tubes 52 such that air can enter the reaction tubes 52 through holes formed therein. Typically, the air flow 80 provided by the fans 62 is intended to provide for substantially evenly distributed reaction rates over the length of the reaction tubes 52 (e.g., the rate at which oxygen from the atmosphere is converted to hydroxyl ions in air electrode 28).

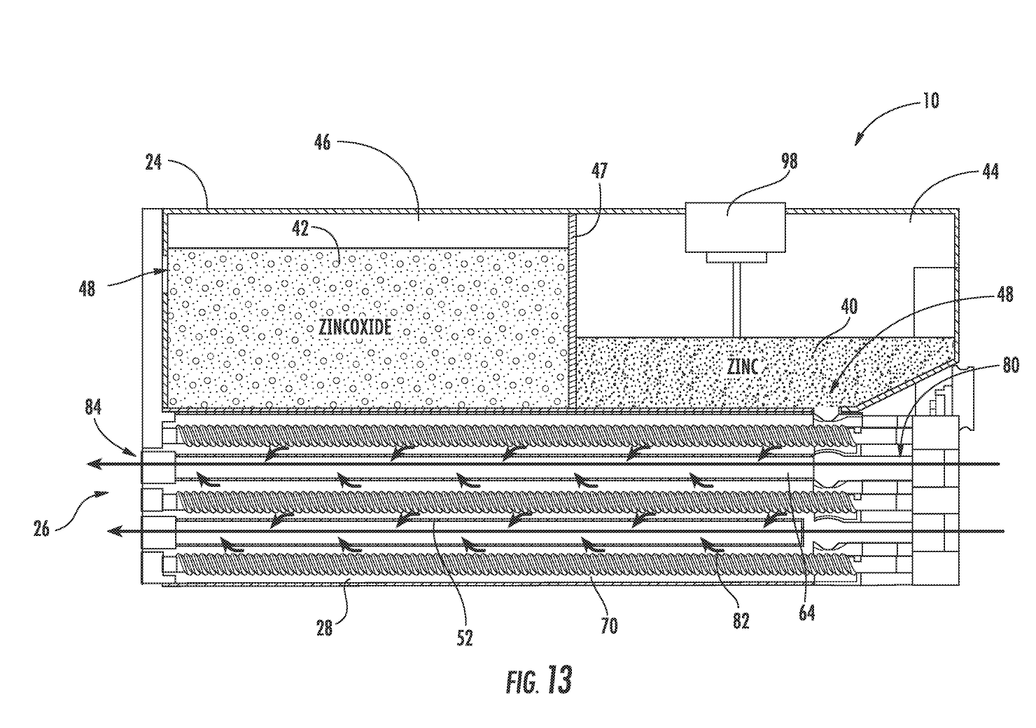

The air flow 80 includes a plurality of air flow paths 82 directed generally from proximate the first wall 56 toward the second wall 58 through the air flow channels 64 according to an exemplary embodiment (see, e.g., FIGS. 11 and 13 illustrating the air flow paths 82). Within the air flow channels 64, the air flow 80 passes between and flows along the outside of the reaction tubes 52. The air flow 80 is discharged from the reactor 26 through an air ventilation system 84 proximate the second wall 58 (see, e.g., FIG. 3, illustrating air ventilation system 84). It should be noted that the air flow and/or air flow paths may vary depending on the configuration of the reaction tubes and/or the application (e.g., the direction of the air flow may vary, multiple sets of fans may be utilized in combination (e.g., spaced apart along the reaction tube, if used with relatively long reaction tubes), etc.). It should also be noted that any ventilation system suitable for providing for the removal of air or other gases from the reactor may be utilized.

The rate of the air flow 80 through the reactor 26 is related to the power consumption of the device or system to which the zinc-air flow battery 10 is coupled. Generally, the greater the current density to be provided to the device or system, the greater the oxygen consumption from the air. It follows that the oxygen provided to the air electrodes 28 must be sufficient to achieve the desired current density. If the oxygen provided is insufficient, a voltage drop can occur between the ends of the reaction tubes 52. For example, the oxygen in an air flow traveling from a first end toward a second end of a reaction tube may be consumed before the air flow reaches the second end. Without oxygen, the charge/discharge reactions are unable to take place along the entire length of each reaction tube, resulting in a voltage drop. Typically, to avoid situations where the oxygen is consumed before the air flow reaches the far end of the reaction tube, approximately two to three times more air than is needed for the electrochemical reaction of oxygen should be directed over the reaction tubes. It should be noted, however, that having the air flow rate too high can have negative effects on the capacity of the zinc-air flow battery, because the air flow may increase the vaporization rate of water from the electrolyte and the rate of CO₂ exposure to the air electrode. Accordingly, the provision of oxygen and the effects of the air flow on vaporization/CO₂ exposure are desirably balanced.

According to an exemplary embodiment, the air flow 80 provided by the fans 62 may further be utilized to remove excess heat from the reactor 26. The heat from the reactor 26 is transferred by convection to the air flow, which moves the heated air through the ventilation system 84 and out of the reactor 26. By removing the excess heat from the reactor 26, overheating at high power levels during discharging and charging of zinc-air flow battery 10 can be prevented.

According to an exemplary embodiment, one or more filters (e.g., a conventional air filter such as one used in cars) may be utilized in combination with the fans to remove dust and other undesirable particles from the air flow and/or the environment surrounding the metal-air flow battery.

According to an exemplary embodiment, a CO₂ scrubber may be used in combination with the fans. The CO₂ scrubber removes CO₂ or reduces the amount of CO₂ to which the air electrode is exposed. According to one exemplary embodiment, the CO₂ scrubbers are replaceable CO₂ scrubbers (e.g., soda lime). According to another exemplary embodiment, the CO₂ scrubbers are regenerative CO₂ scrubbers (e.g., carbon filters regenerated by heat).

While the fans 62 provide an air flow 80 along the exterior of the reaction tubes 52, the feed system 60 is configured to provide for distribution and transport of the zinc paste 40 and the zinc oxide paste 42 through the reaction tubes 52 of the zinc-air flow battery 10. Referring to FIGS. 2-6, the feed system 60 is shown including a plurality of conduits, including a plurality of zinc inlet/outlet conduits 86 and one or more zinc oxide inlet/outlet conduits 88, a plurality of mechanisms for moving the anode paste material through the passages 70 of the reaction tubes 52, shown as screws or augers 90 (e.g., archimedean screws, screw devices, etc.), and one or more motors 92 according to an exemplary embodiment.

Referring to FIGS. 2-4, the zinc inlet/outlet conduits 86 and the zinc oxide inlet/outlet conduits 88 allow for the zinc paste 40 and the zinc oxide paste 42 to be moved into and out of the reaction tubes 52 during operation of the zinc-air flow battery 10 according to an exemplary embodiment. The zinc inlet/outlet conduit 86 and the zinc oxide inlet/outlet conduits 88 are fluidly connected to the tank 24 at inlets/outlets 48, 50 and are fluidly connected to the reaction tubes 52, providing for the pastes 40, 42 to travel between the tank 24 and the reaction tubes 52.

According to an exemplary embodiment, the zinc inlet/outlet conduits and the zinc oxide inlet/outlet conduits are shown made of or coated in a polymeric material to prevent corrosion (e.g., as a result of galvanic coupling). According to other exemplary embodiments, any conduits or other elements suitable for allowing the pastes to be moved into and out of the reaction tubes during operation of the zinc-air flow battery may be used. More generally, these conduits, as well as any valves, fittings and other components of the zinc-air flow battery through which the pastes flow or in which the pastes are stored are configured to prevent corrosion, erosion, leakage, or other failure mechanisms (e.g., by being made of plastic, by using coatings, etc.), improving the shelf and operational life of the zinc-air flow battery.

The pastes 40, 42 are transported from the tank 24 to the inlet/outlet tubes 86, 88 by a feed mechanism according to an exemplary embodiment. In one exemplary embodiment, the feed mechanism includes a gravitational tap feeder or pump. According to other exemplary embodiments, other suitable feed mechanisms may be used (e.g., pumps, etc.). According to an exemplary embodiment, the feed mechanism is configured to equally distribute the pastes among the reaction tubes.

Referring to FIGS. 3-6, the screws 90 are configured to move the pastes 40, 42 through the reaction tubes 52 and to help move the pastes 40, 42 into and out of the tank 24 according to an exemplary embodiment. The screws 90 are shown disposed within the reaction tubes 52, extending generally between the first end portion 66 and the second end portion 68, and rotatably coupled between the first wall 56 and the second wall 58. Rotating the screws 90 in a first direction provides for transport of the zinc paste 40 received from the first cavity 44 proximate the first wall 56 through the reaction tubes 52 and toward the second wall 58. Rotating the screws 90 in a second direction, opposite the first direction, provides for transport of the zinc oxide paste 42 received from the second cavity 46 proximate the second wall 58 through the reaction tubes 52 and toward the first wall 56. The configuration, rotation, and/or disposition of the screws 90 within the base 110 of the reaction tubes 52 is intended to create desired force and pressure to transport (e.g., push, pump, move, direct, etc.) the zinc paste 40 and the zinc oxide paste 42. According to another exemplary embodiment, the system may be configured such that the screws operate to rotate in only one direction (e.g., where the same tank is used both for charged and discharged zinc, as described below with respect to FIG. 14).

In addition to moving the pastes, the rotation of screws 90 may be configured to help keep zinc electrode 20 and electrolyte 22 sufficiently mixed and/or to substantially maintain desired flow characteristics (e.g., viscosity, etc.) for zinc paste 40 and/or zinc oxide paste 42. By helping to mix of zinc paste 40 and zinc oxide paste 42, screws 90 may help keep these pastes substantially homogeneous. As discussed above, it is desirable for these pastes to be substantially homogenous to provide for more consistent reactions as well as other benefits. Further, maintaining desired flow characteristics of the zinc paste 40 and/or the zinc oxide paste 42 may provide numerous benefits (e.g., limiting erosion of the elements of the reaction tubes (e.g., the air electrode) as the paste is transported therethrough, etc.).

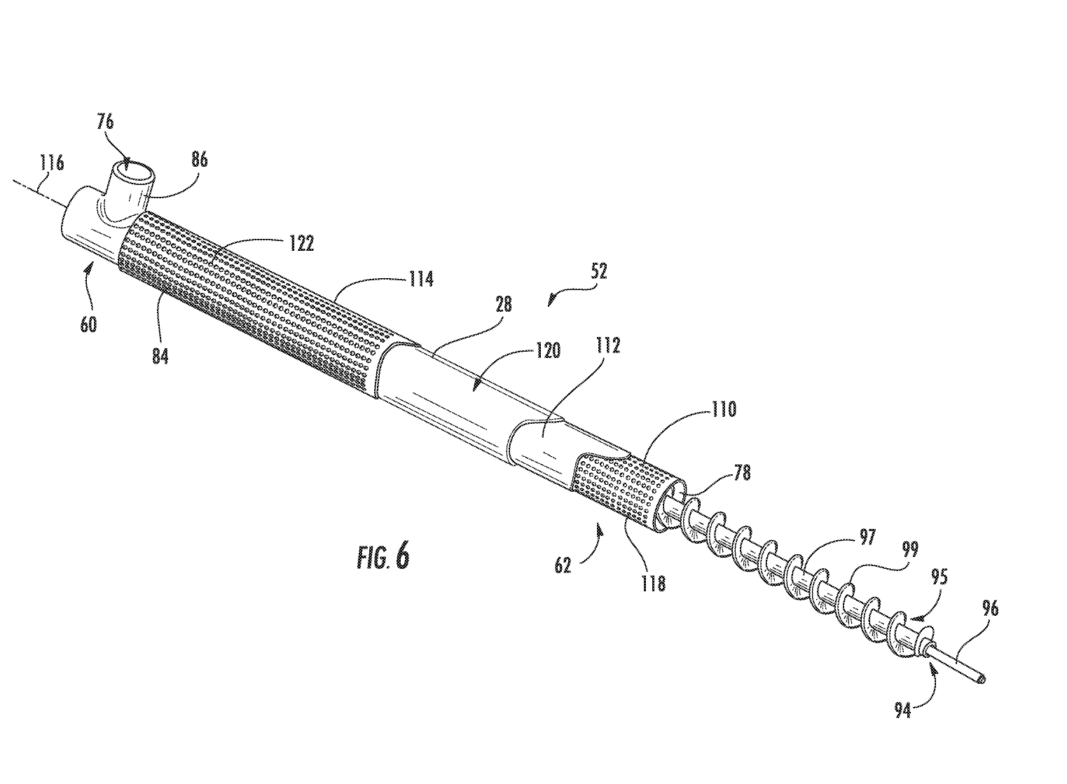

Referring in particular to FIG. 6, the screws 90 are configured to function as the current collector for the zinc paste 40 (i.e., the anode or negative current collector) according to an exemplary embodiment. The screws 90 are shown including a shaft portion 94 and a threaded portion 95 including a thread 99. The shaft portion 94 is made of an electrically conductive material. In exemplary embodiment shown, this electrically conductive material is indium-coated copper; though, any suitable electrically-conductive material may be used according to other exemplary embodiments. The shaft portion 94 is shown substantially centered in the middle of the zinc paste flow, providing for a desirable electric field distribution, and, accordingly, a substantially homogenous current distribution.

The shaft portion 94 is shown including an interior shaft portion, shown as a fixed rod 96, and an exterior portion, shown as a tube 97. The fixed rod 96 is connected to the power input/output device 30 for the zinc-air flow battery 10, and does not move and is also electrically coupled to the tube 97 and the pastes 40, 42. The fixed rod 96 of the shaft portion 94 is further fixedly coupled to a control system 98, discussed in more detail below, providing an electrical contact thereto and allowing the current collected from the pastes 40, 42 to be transported to the power input/output device 30 (i.e., current flows from the paste to the tube 97, through bearings 100, to the fixed rod 96, to the power input/output device 30).

The tube 97 is configured to rotated relative to the fixed rod 96 and is in conductive electrical contact with the pastes 40, 42 according to an exemplary embodiment. As will be discussed in more detail below, the tube 97 is coupled to a gear 104 that is coupled to a motor 92, which provides rotational motion to the tube 97. According to the exemplary embodiment shown, a plurality of bearings 100 formed from an electrically conductive material are provided to allow for movement of the tube 97 relative to the fixed rod 96 while maintaining electrical contact therebetween. According to other exemplary embodiments, any element or device suitable for allowing for movement of the tube 97 relative to the fixed rod 96 while maintaining an electrical contact therebetween may be used in place of or in addition to the bearings (e.g., brushes, ball bearings, conductive powder, etc.).

Referring further to FIG. 6, the threaded portion 95 of the screws 90 including the thread 99 is shown extending generally outward and about the tube 97 of the shaft portion 94 according to an exemplary embodiment. The threaded portion 95 is configured to rotate with the tube 97 relative to the fixed rod 96 in order to drive or move the pastes 40, 42. In the exemplary embodiment shown, the threaded portion 95 is integrally formed with the tube 97. Accordingly, rotation of the tube 97 causes the threaded portion 95 to rotate, thereby providing for the threaded portion 95 to drive or move the pastes 40, 42. According to other exemplary embodiments, the threaded portion may be otherwise coupled to the tube. For example, the thread of the threaded portion may be formed with a polymeric material about the tube of the shaft portion.

According to an exemplary embodiment, a coating 101 is disposed on the thread 99 of the threaded portion 95 (but not on the tube 97). The coating 101 is configured to provide a number of benefits, which will be discussed in more detail below (e.g., reducing friction, reducing erosion, etc.). According to the exemplary embodiment shown, the coating 101 includes a polymeric material. According to other exemplary embodiments, the threaded portion and/or other portions/components of the screws 90 may be made of (rather than simply coated with) a polymeric material. According to still other exemplary embodiments, any suitable material (e.g., metal, plastic, ceramic, etc.) may be used for the threaded portion of the screws.

According to alternative exemplary embodiments, elements other than the screws may be used as the current collector for the zinc paste 40. For example, one or more layers of the reaction tube 52 (e.g., a base 110) may be configured to act as the current collector for zinc paste 40. In these exemplary embodiments, the element acting as the current collector is typically made of a metal having a high hydrogen overpotential (e.g., copper, brass, indium, indium-coated copper, zinc, palladium, bismuth, tin, etc.).

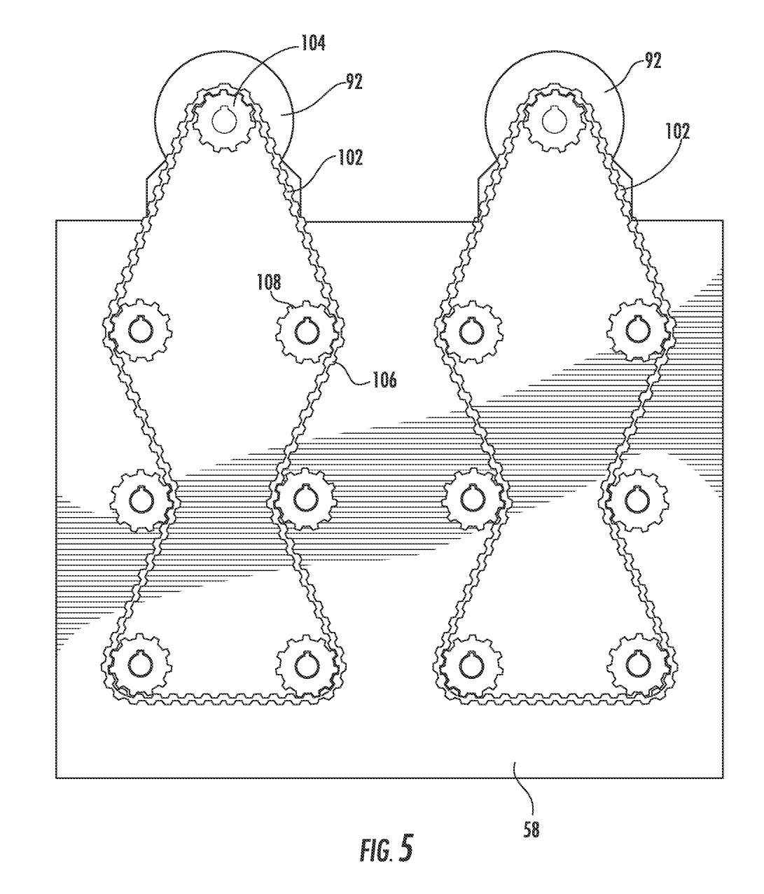

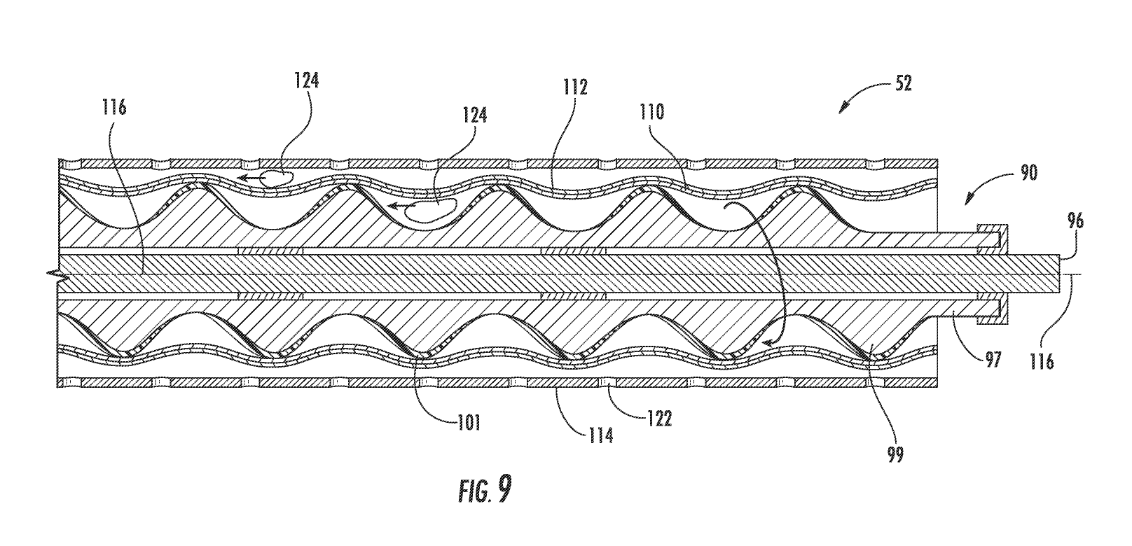

Referring to FIG. 5, one or more motors 92 (e.g., a brushless DC motor) operably impart motion to the screws 90 using one or more belts 102 and a plurality of gears 104 according to an exemplary embodiment. The gears 104 are coupled to an output shaft of the motor 92 and to the tubes 97 of the screws 90 at an end corresponding substantially to the second end portion 68 of the reaction tubes 52 by welding, crimping, or any other suitable method (see, e.g., FIG. 9 more clearly illustrating the end of the tube 97 that is coupled to the gear 104). The belts 102 interconnect the gears 104, allowing for movement of several screws 90 by a single motor 92. The belt 102 includes a plurality of teeth 106 and the gears 104 include a plurality of teeth 108. The teeth 106 of the belt 102 are configured to mesh with the teeth 108 of the gears 104, such that the motion of the belt 102 imparts motion to the gears 104. As the output shaft of the motors 92 rotate, the gears 104 coupled to the output shaft rotate. The rotation of the gear 104 coupled to the output shaft of the motor 92 drives the belt 102. The movement of the belt 102 rotates the gears 104 because of the interaction between the teeth 106, 108, and, thus, rotates the tubes 97 (and, thus, the threaded portions 95) of the screws 90. While the belt 102 is shown double-sided (e.g., having teeth on both the interior side and the exterior side), other belts having other configurations may be used. For example, a single-sided belt (e.g., having teeth on only one side) may be used for an arrangement of reaction tubes that are all aligned. According to other exemplary embodiments, elements other than or in addition to gears and belts may be used to drive the feed system. According to an exemplary embodiment, the belt 102 and gears 104 are located on the outside wall that supports the positioning of the tubes.

The rotational speed of the screws 90 is related to the discharge rate of the zinc-air flow battery 10. Generally, the greater the rotational speed of the screws, the greater the rate at which the zinc paste 40 and/or the zinc oxide paste 42 are transported through the reaction tubes 52. Generally, the greater the rate of transport of the zinc paste 40 and/or the zinc oxide paste 42 through the reaction tubes 52, the greater the reaction rate. Generally, the greater the reaction rate, the greater the corresponding rate of charge/discharge. Accordingly, the charge/discharge rate of the zinc-air flow battery 10 may be adjusted by adjusting the rate at which the motor 92 rotatably drives the screws 90. While it is generally desirable for the feed system 60 to transport the pastes 40, 42 through the reaction tubes 52 at a constant rate along the entire length, the rates at which the screws 90 are rotated (and, thus, the pastes are transported) may vary according to other exemplary embodiments.

According to an exemplary embodiment, the reaction tubes 52 include air electrodes 28 disposed between at least two protective layers. FIG. 6 illustrates one of the reaction tubes 52 of the zinc-air flow battery 10 in more detail according to an exemplary embodiment. The reaction tube 52 is shown having a layered configuration that includes an inner tube or base 110, a separator 112, an air electrode 28, and an outer tube or protective casing 114 according to an exemplary embodiment. The base 110 is shown as the innermost layer of the reaction tube 52, the protective casing 114 is shown as the outmost layer of the reaction tube 52 and defining an outer surface of the reaction tube 52. The other layers are shown disposed substantially between and concentric with the base 110 and the protective casing 114.

Referring to FIG. 6, the base 110 substantially defines the passage 70, shown extending along a longitudinal axis 116 of the reaction tube 52, and provides support (e.g., mechanical stability) for the outer layers of the reaction tube 52, which are disposed thereabout and coupled thereto, according to an exemplary embodiment. The passage 70 of the reaction tube 52 receives the zinc paste 40 and the zinc oxide paste 42 as they are transported through reactor 26 of the zinc-air flow battery 10. The passage 70 (e.g., channel, conduit, etc.) is shown extending substantially between a zinc inlet/outlet 76 and a zinc oxide inlet/outlet 78 of the reaction tube 26. The zinc oxide inlet/outlet 78 is shown disposed proximate to the first end portion 66 of the reaction tube 52 to provide for transport of the zinc oxide paste 42 into and out of the passage 70 of the reaction tube 52. The zinc inlet/outlet 76 is shown disposed proximate to the first end portion 66 of the reaction tube 52 to provide for transport of the zinc paste 40 into and out of the passage 70 of the reaction tube 52.

The base 110 further includes a plurality of openings 118 according to an exemplary embodiment. The openings 118 (e.g., apertures, holes, etc.) are configured to allow fluids to flow (e.g., be transported, be diffused, be distributed, etc.) through the base 110. As discussed above, the air electrode 28 is disposed generally to the exterior of the base 110 and the pastes 40, 42 are intended to flow through the passage 70 interior to the base 110. Accordingly, by extending through the base 110, the openings 118 provide for the electrolyte 22 (and possibly other fluids) to flow through the base 110 and between the cathode and anode materials, facilitating the electrochemical reaction between zinc electrode 20 and air electrode 28 within reactor 26.

The base 110 is configured to minimize the erosion effects of zinc paste 40 and/or zinc oxide paste 42 on separator 112 and air electrode 28 according to an exemplary embodiment. Without the base 110, the zinc paste 40 and/or zinc oxide paste 42 would be in direct contact with the separator 112 and/or the air electrode as it is fed through the passage 70. This direct contact would cause these reaction tube 52 components to erode (e.g., due to the friction and resultant shear stresses therebetween), shortening the life of the reaction tube 52 and possibly the zinc-air flow battery 10 itself. Accordingly, by locating the base 110 generally between the reaction tube components exterior thereto (e.g., the separator 112 and the air electrode 28) and the zinc paste 40 (and/or the zinc-oxide paste 42), undesirable contact between the zinc paste 40 (and/or the zinc-oxide paste 42) and some of the other reaction tube components is minimized or prevented altogether.

Additionally, the base 110 may be made of one or more materials intended to help minimize erosion. For example, in the exemplary embodiment shown, base 110 is shown made of plastic. Using plastic helps minimize friction and shear stresses, and, thus, erosion (e.g., because of the relatively low coefficient of friction for plastic, etc.). Plastic also provides benefits, including, but not limited to, helping avoid corrosion due to galvanic coupling and facilitating gas removal from the reaction tubes, as will be discussed in more detail below. According to another exemplary embodiment, the base may be plastic-coated (e.g., plastic-coated aluminum). According to other exemplary embodiments, the base may be made of any material that helps minimize or avoid erosion and/or corrosion (e.g., a metal that gives high hydrogen overpotentials (e.g., copper, brass, etc.) to reduce corrosion of zinc-forming hydrogen).

Referring further to FIG. 6, the separator 112 extends substantially circumferentially about the base 110 and at least partially along the longitudinal axis 116 of the reaction tube 52 according to an exemplary embodiment. The separator 112 is configured to prevent the short circuiting of the reactor 26. The separator 112 is shown disposed between the air electrode 28 and the zinc electrode 20 and made of plastic. In some exemplary embodiments, the separator 112 is made of polypropylene or polyethylene that has been treated to develop hydrophilic pores which are configured to fill with the electrolyte 22. In other exemplary embodiments, the separator may be made of any material configured to prevent short circuiting of the reactor and/or that includes hydrophilic pores. According to an exemplary embodiment, the separator is made of polyethylene, which provides good stability and provides good wetting ability (i.e., with the electrolyte). According to some exemplary embodiments, other plastics may be utilized. According to still other exemplary embodiments, any substantially any material that may be wetted by the electrolyte (e.g., absorb the electrolyte) may be used (e.g., ceramic separators, etc

Referring further to FIG. 6, the air electrode 28 is shown as being substantially tubular, extending substantially circumferentially about the separator 112 and at least partially along the longitudinal axis 116 of the reaction tube 52 according to an exemplary embodiment. The air electrode 28 is a secondary air electrode that is configured to act as an electrical conductor through which electric current flows out during discharge of the zinc-air flow battery 10 (i.e., the outer tube of the air electrode is formed of an electrically conductive material such as a metal, and acts as a current collector). The air electrode 28 may include one or more layers. In the exemplary embodiment shown, the air electrode includes an active layer and a gas diffusion layer. According to other exemplary embodiments, the air electrode may include other combinations of layers (e.g., an active layer, a gas diffusion layer, an oxygen evolution layer, and an oxygen reduction layer).

The composition of the air electrodes 28 provides for production of tubular air electrodes according to an exemplary embodiment. The air electrodes 28 include a binder 120 that provides for increased mechanical strength of the air electrode 28, while providing for maintenance of relatively high diffusion rates of oxygen (e.g., comparable to more traditional air electrodes). According to one exemplary embodiment, binder 120 includes polytetrafluoroethylene (“PTFE”) binders. According to other embodiments, binder 120 may include, but are not limited to, polymers and/or other materials that are hydrophobic and stable in an alkaline environment; these materials may be utilized alone or in combination.

The binder 120 may provide sufficient mechanical strength to enable the air electrode 28 to be formed in a number of manners, including, but not limited to, one or a combination of stamping, pressing, utilizing hot plates, calendaring, etc. According to one exemplary embodiment, the air electrode 28 is formed in a flat sheet and then wrapped (e.g., formed, etc.) about the base 110 and the separator 112 into a tubular shape. The relatively high mechanical stability provided by the binder 120 allows for this wrapping to occur substantially without crack formation. To maintain the air electrode 28 in the tubular configuration, the adjacent edges of the air electrode sheet are coupled, forming a seam (e.g., by gluing, by welding, etc.). According to other exemplary embodiments, the air electrode may be configured to correspond to a reaction conduit that is non-tubular (e.g., the conduit has an oval-shaped cross section, has a polygonal cross section, etc.) or otherwise shaped to permit transport of zinc paste and zinc oxide paste therethrough. Further, while the reaction tubes are shown as having a constant radius and cross-section, in other embodiments, the radius and/or cross section of the reaction tube may vary along the longitudinal axis.

The improved mechanical strength of air electrode 28 due to the incorporation of the binder 120 may further reduce the erosion effect of a flow through zinc-air flow battery 10. The binder 120 results in an air electrode having a smooth surface and relatively tight bindings (e.g., between the binders and carbon). The smooth surface and tight bindings may allow for the air electrode 28 to be handled substantially without the removal of carbon because of the improved binding properties, thereby reducing erosion. The binder partially coats the carbon and limits the erosion effect on the air electrode, which may be caused due to the flow and gas evolution.

The surface area of the air electrode 28 is substantially proportional to its rate capability. Accordingly, the surface area of the air electrodes 28 may be increased or decreased to help achieve a desired discharge/charge rate and/or to achieve a desired power density. In the exemplary embodiment shown, the surface area of the air electrode 28 is calculated by multiplying the length of the air electrode 28 by its circumference. Thus, the length and/or circumference of the air electrode may be increased to accommodate a higher current density/larger load.

As discussed above, it is desirable to have a flat discharge curve along the length of the reaction tube to minimizes the voltage drop over the length of the reaction tube, from end-to-end. If the paste fully discharges before existing the reaction tube, a portion of the reaction tube will not take part in the reaction. It follows that less of the air electrode surface area takes part in the reaction. It also follows that the resulting voltage drop would result in the reaction tube discharging at a relatively low voltage, which can cause damage to the air electrode.

According to an exemplary embodiment, the air electrodes and the reaction tubes in which they are used do not have to be optimized for energy storage, as with many conventional batteries. The structure of the zinc-air flow battery 10 provides for splitting energy storage and energy conversion. Accordingly, the designs of the air electrodes for a zinc-air flow battery can be focused on optimizing and/or improving their cycle life, efficiency, and power.

The air electrode 28 may further include a siloxane layer provided in the form of a film or membrane adjacent the holes of the reaction tube (not shown) according to an exemplary embodiment. The siloxane layer has selectivity for oxygen and reduces the transport of water vapor and carbon dioxide into the reaction tubes. One advantageous feature of the siloxane layer is that it may act to prevent flooding and/or drying out of the zinc-air flow battery 10. The siloxane layer may be made of any a number of types and/or forms of siloxane. In one exemplary embodiment, the siloxane layer includes siloxane Geniomer® 80 from Wacker Chemie AG of Munchen, Germany. In other exemplary embodiments, the siloxane layer may be used in combination other layers (e.g., the gas diffusion layer) to achieve a desired selectivity for oxygen, water vapor management, and carbon-dioxide management for zinc-air flow battery 10.

Referring further to FIG. 6, the protective casing or shroud 114 extends substantially circumferentially about the air electrode 28 and at least partially along the longitudinal axis 116 of the reaction tube 52 according to an exemplary embodiment. The protective casing 114 is configured to protect/prevent damage to air electrode 28, to act as the current collector for air electrode 28 (which may be coupled electrically to the power input/output device 30), and/or to resist corrosion. The protective casing 114 includes a plurality of openings 122 configured to allow fluids to flow therethrough to react with the air electrode 28. Gases (e.g., air and/or oxygen) can flow (e.g., be diffused, be distributed, etc.) through the openings 122, into the reaction tube 52, and toward the passage 70. Similarly, gases (e.g., hydrogen and carbon dioxide) can flow away of the passage 70 and out of reaction tube 52 through the openings 122. In the exemplary embodiment shown, the protective casing 114 is made of nickel-coated steel. In other exemplary embodiments, the protective casing may be made of nickel, stainless steel, copper, or any other conductive metal or metal alloy with at least some resistivity toward the materials of the electrolyte.

Referring to FIGS. 2-4 and 6, the tubular configuration of the reaction tubes 52 provides for the air electrodes 28 to be relatively easily assembled and installed substantially without leakage. Leakage may result in increased impedance, increase capacity loss, and decrease the lifespan of the zinc-air flow battery 10. Leakage might also damage peripheral designs.

One way the tubular configuration helps prevent leakage is by allowing current collectors for the anode and the cathode to be strategically positioned to minimize leakage. For the air electrodes 28, the tubular configuration allows for the current collector to be disposed at or proximate to the exterior of the reaction tubes 52. Locating the current collector (here, the protective casing 114) at the exterior of the air electrode 28 substantially avoids any leakage that might result if the current collector were disposed internal to the air electrode.

For the zinc electrode 20 (incorporated in the pastes, as explained above), the tubular configuration of the shaft portions 94 allows for the current collector to be integrated substantially within the reaction tubes 52 (e.g., the fixed rod 96 of the screws 90, as discussed above, where the shaft portion 94 includes a hollow tube with a fixed rod inside that allows for the contact pin to remain fixed while the shaft rotates). By integrating the current collector for the zinc electrode 20 within the reaction tubes 52, contact pins (used in conventional batteries) can be avoided. Accordingly, the leakage typically associated with these contact pins can be avoided.

The tubular configuration of the reaction tubes 52 further helps avoid leakage because it allows for the use of cylindrical seals between the tube and the feed port. Pressure is distributed substantially on the cylindrical seals. In this way, there are fewer relatively weak portions of the seal that may be more susceptible to leakage.

Other benefits of the tubular configuration include, but are not limited to, improved resistance of the air electrode 28 to pressure, erosion (e.g., during transport of zinc paste 40 and zinc oxide paste 42, etc.), and flooding. For example, the tubular configuration of the air electrode permits zinc paste to flow through passage 70 with less friction than if the air electrode were configured as a flat plate, causing relatively less erosion therewithin. Also, the layered configuration of the cylindrical reaction tubes 52 allows for incorporation of elements/layers providing mechanical stability and helping to provide improved pressure resistance (e.g., the base 110).

Referring to FIGS. 2-3 and 6, the desirable length of each reaction tube 52 may be selected based at least in part on the rate of reaction per unit of the surface area of its air electrode 28. As discussed above, it is generally the case that the greater the surface area of the air electrode 28, the greater its rate capability. However, oxygen from the air flow 80 is consumed as it flows along the length reaction tubes 52. In order to maintain a substantially constant reaction rate along the surface of the air electrode 28 (e.g., to avoid a voltage drop, as discussed above), the amount of oxygen directed along the reaction tubes 52 may be adjusted (e.g., changing the rate of the air flow) or the length of the reaction tubes 52 may be adjusted. Because the amount of oxygen directed along the reaction tubes 52 cannot be increased indefinitely, the length of the reaction tubes 52 is necessarily limited.

Referring further to FIGS. 2-3 and 6, the desirable length of the reaction tubes 52 may also be selected based at least in part on the flow properties of the pastes 40, 42. It is desirable for the feed system 60 to transport the pastes 40, 42 through the reaction tubes 52 at a constant rate along the entire length. Maintaining a constant transport rate for the pastes 40, 42 typically becomes more difficult as the length of a reaction tube 52 increases. Using feed system 60 as an example, the screws 90 may be limited by their stiffness. Stated otherwise, the rate of rotation at one end of the screw 90 may differ from the rate of rotation at the other end of the screw 90 because of flexing or bending. This flexing or bending may result from the interaction of the screw 90 and the paste 40, 42. Generally, less viscous pastes will provide less resistance to the rotation of the screws. However, less viscous pastes typically include less zinc anode material and may not provide the desired capacity. It should also be noted that narrower tubes (i.e., tubes with relatively small cross-sections) may also make the transport of the pastes more difficult. Accordingly, more complex feed systems may be required to achieve desired discharge rates.

According to an exemplary embodiment, each reaction tube 52 is electrically connected with the other reaction tubes 52 in series or parallel and configured to deliver a voltage within a voltage range when the circuit is open/during discharge (e.g., approximately 0.6V to approximately 1.4V for each tube, etc.). Similarly, the voltage across each reaction tube may fall within a generally higher voltage range during charging (e.g., approximately 1.7V to approximately 2.3V for each tube, etc.). The upper limit of the charging voltage range may be limited by hydrogen evolution during the reaction; this evolution may decrease efficiency of the reaction. According to other exemplary embodiments, the reaction tubes may be connected in parallel to deliver a desired voltage for a given application.

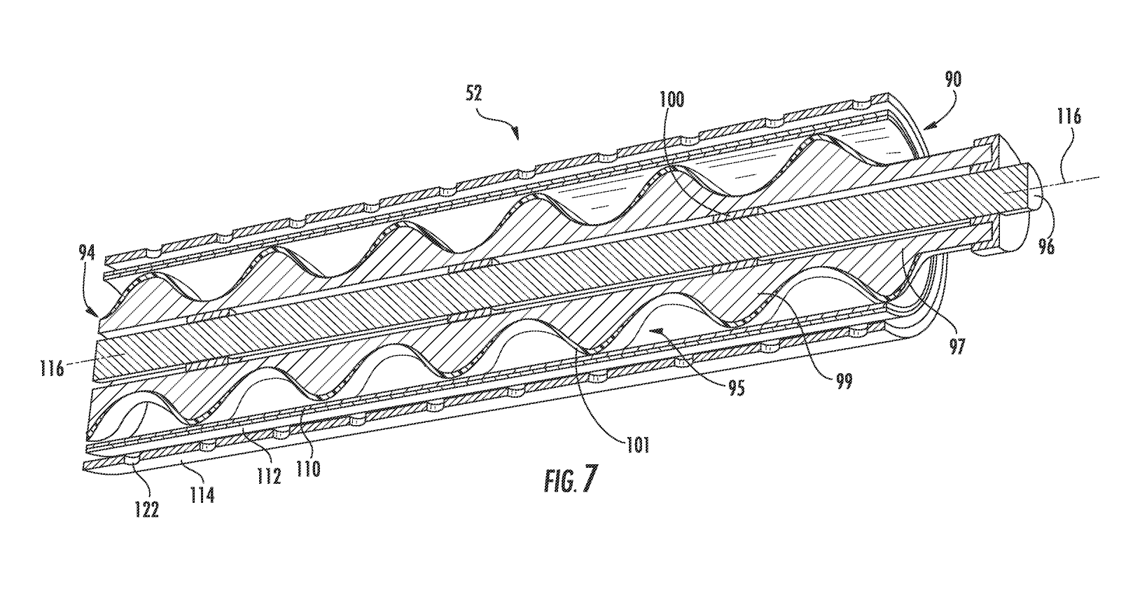

FIGS. 7-9 show cross-sections of one of the reaction tubes 52 assembled with one of the screws 90 disposed therein according to an exemplary embodiment. As mentioned above, the pastes 40, 42 can be configured to maintain desirable flow properties, while providing for relatively high capacities during operation of the zinc-air flow battery 10. It should be noted that the cross sections of the screw shown in FIG. 6 and the screws shown in FIGS. 7-9 are interchangeable.

Generally, the viscosity of zinc paste 40 and/or zinc oxide paste 42 may be adjusted by adjusting the ratio of electrolyte 22 to zinc electrode 20. The higher the ratio of electrolyte 22 to zinc electrode 20 per unit weight, the less viscous and less dense the paste. Less viscous pastes flow more easily (e.g., creating less friction with and lower shear stresses between the pastes and the reaction tubes). Less viscous pastes also generally provide for better utilization of zinc electrode 20. However, because there is less zinc electrode 20 in the paste, the specific capacity may be relatively low. In some cases, the specific capacity may not be suitable for a desired application. Conversely, the lower the ratio of electrolyte to zinc paste per unit weight, the more viscous and more dense the paste. More viscous pastes generate more friction and shear stress as they flow through the reaction tubes. Also, despite the fact that the utilization rate for a more viscous paste may not be as good as for a less viscous paste, more viscous pastes tend to provide for higher specific capacity/electrochemical storage capacity (e.g., in amp hours).

The zinc paste 40 and the zinc-oxide paste 42 may be successfully utilized in a variety of densities. According to one exemplary embodiment, the density of the pastes may be within a range of approximately 0.5 g/ml-5 g/ml. As mentioned above, denser paste generally provide for greater electrochemical storage capacity (e.g., in amp hours).

Referring to TABLE 1 below, the results of a capacity test on an exemplary embodiment of a zinc paste are shown according to an exemplary embodiment. Three different densities of a paste including zinc (GHN-10-0/500Pb/300Bi/300In) commercially available from Grillo-Werke AG of Duisburg, Germany were tested. The electrolyte used included KOH and carboxylic acid (e.g., to help prevent the zinc anode material from settling).

TABLE 1

| Zinc Paste | Specific Capacity | Volumetric Capacity |
|---|---|---|
| Density (g/ml) | (Ah/g) | (Ah/ml) |
| 2.0 | 0.45787 | 2.15 |
| 3.0 | 0.65584 | 1.967 |
| 4.7 | 0.5887 | 1.17 |

The results for this paste indicate that, of the pastes tested, the paste having a density of approximately 3.0 g/ml provided the best overall performance. The 3.0 g/ml paste provided the highest specific capacity (0.65584 Ah/g) and the second highest volumetric capacity (1.967 Ah/ml). Other tests were conducted to confirm that the 3.0 g/ml paste would also provide good flow properties. For example, at a viscosity of approximately 28 Pas, the 3.0 g/ml paste was measured to have a shear rate of approximately 2 l/s.

A paste can be substantially optimized for the reaction tube with which it will be used (e.g., considering the cross-section, length, etc.). According to an exemplary embodiment, a substantially optimized zinc paste can be used with a reaction tube (e.g., having a low-erosion design) to yield utilization in substantially the same range as primary zinc batteries (80-90%). This is evidenced, for example, with the test results for the 3 g/ml paste discussed in relation to TABLE 1 above. As indicated in TABLE 1, the paste provided a capacity of more than 655 mAh/g for 3.0 g/ml paste, which corresponds to approximately 73% utilization (of the theoretical 816 mAh/g).

According to an exemplary embodiment, the density and flow characteristics of the paste may be adjusted during use or between uses of zinc-air flow battery 10. For example, a liquid (e.g., electrolyte or water) may be added through a filling hole (e.g., in tank 24). A mixing device may then be used to achieve a homogeneous paste to be fed through the reactor 26. It should also be noted that a paste may be removed and replaced with a new or different batch of paste.

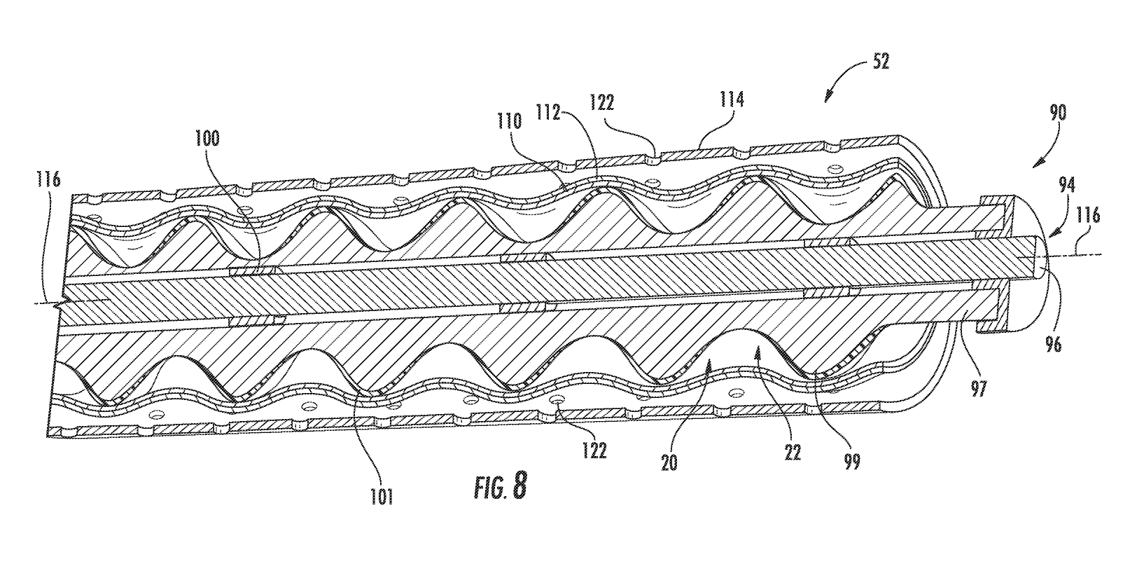

Referring to FIG. 8, one of the reaction tubes 52 is shown during operation of the zinc-air flow battery 10 according to an exemplary embodiment. The transport of the pastes 40, 42 through the reaction tubes 52 during operation provides a number of lifespan-extending and performance-enhancing benefits for the zinc-air flow battery 10.

First, as discussed above, the pastes 40, 42 are transported into and out of the tank 24 in a manner that allows for reduced exposure of the electrolyte 22 and zinc electrode 20 included in the pastes 40, 42 to the environment.

Second, shape changes and dendrites are reduced or prevented as the pastes 40, 42 are transported through the reaction tubes. Dendrites or shape changes of the zinc electrode is typically one of the primary life cycle-limiting factors for secondary zinc-based batteries. The high power capability of the zinc electrode is at least in part a result of the formation of zincate and/or other zinc salts in the electrolyte (e.g., alkaline media); the zincate helps prevent passive film formation on the zinc. In conventional secondary zinc-based batteries, as the mobility of zincate is high in a liquid electrolyte, the zincate concentration in the inter-phase between the air electrode and the zinc electrode increases with depth of discharge. When saturation is reached, zinc oxide is formed. The formation and dissolution of zinc oxide is the rate determining step for charging the zinc electrode. Due to the low dissolution rate of zinc oxide when charging the zincate in the inter-phase will react (especially for high rate charging), this deposition of zinc in the inter-phase causes the formation of dendrites. It should be noted that uneven current distribution, gravimetric effects and density variation going from zinc to zinc oxide can also create shape changes within the zinc electrode.

In the zinc-air flow battery 10 shown, the dendrite formation is substantially prevented by microscopic localization of the zinc reaction. As the pastes 40, 42 are transported through the reaction tubes 52, it reduces the build up of concentration gradients for the zincate. By reducing the concentration gradients for zincate, the dendrites are substantially prevented from forming. Any dendrites that do form are substantially prevented from stabilizing as the paste is moved through the passages 70 of the reaction tubes 52. Preventing stable dendrites helps minimize the risk of internal short circuits.

Further, shape change is reduced as the paste is substantially continuously mixed by the screws 90. In fact, the density variation between zinc and zinc oxide in the pastes 40, 42 may be controlled by the forced flow process (i.e., the operation of the feed system 60, as described above). The forced flow process may be configured to substantially counter any gravimetric effects. With each pass, depending on the depth of discharge, a mixture of zinc and zinc oxide is transported back into the tank. The high viscosity of the paste limits the mixing or settling of paste with varying density. Note that the tank may be configured as shown in the accompanying drawings or may include only a single tank, as described above.

Third, the transport of the pastes 40, 42 through the reaction tubes 52 during operation substantially removes any undesirable gas formation. The formation of gas inside a zinc-air battery is detrimental to the operational life of the system. The formation of hydrogen by the corrosion of the zinc will reduce the shelf life of the battery and the formation of hydrogen during charging of the battery will reduce the charge efficiency. Gas nucleation in the inter-phase between the electrodes can cause uneven current distribution, resulting in dendrite formation, reduced capacity, and formation of dry spots that substantially fail to take part in further charge and discharge reactions. Gas formation can take place both on the air electrode and the zinc electrode. For the air electrode oxygen formation takes place during charging. At moderate current densities the oxygen is vented out of the air electrode by the hydrophobic channels of the construction. With high power charging, the risk is increased for the formation of oxygen in the inter-phase. It should be noted that the formation of oxygen is a part of the charge reaction and does not reduce efficiency or shelf life as does hydrogen formation on the zinc electrode. Obtaining low hydrogen gas formation rates from the zinc electrode to increase shelf life and charge columbic efficiency may be accomplished through the use of alloying elements such as bismuth and indium. High hydrogen overpotential metals, such as indium, suppress hydrogen formation since they increase the voltage for hydrogen evolution. This ensures that the hydrogen over-potential remains high when the electrode is exposed to charge voltages.

Referring to FIGS. 8-9, the threaded portion 95 of the screws 90 is shown having a diameter slightly larger than the internal diameter of the innermost layer of the reaction tubes 52 (the base 110) according to an exemplary embodiment. When the screws 90 rotate, the threaded portion 95 pushes against the base 110, causing the base 110 and the air electrode 28 to flex (e.g., in an undulating manner). As the screws 90 push against the base 110, nucleated gases (e.g., gas bubbles 124) are urged toward the base 110 and out of the reaction tube 52 through the openings 118 formed in the outer surface thereof. When the paste arrives back into the tank 24, the nucleated gases are easily vented therefrom (e.g., through a venting valve provided as part of the tank; as an alternative, a recombination catalyst in the tank can recombine oxygen and hydrogen to form water, which may advantageously help to reduce water loss in the system), helping improve the power, efficiency, and cycle performance of the zinc-air flow battery 10 (e.g., by preventing and reducing dry spots (caused by the gases) that may increase impedance, etc.).

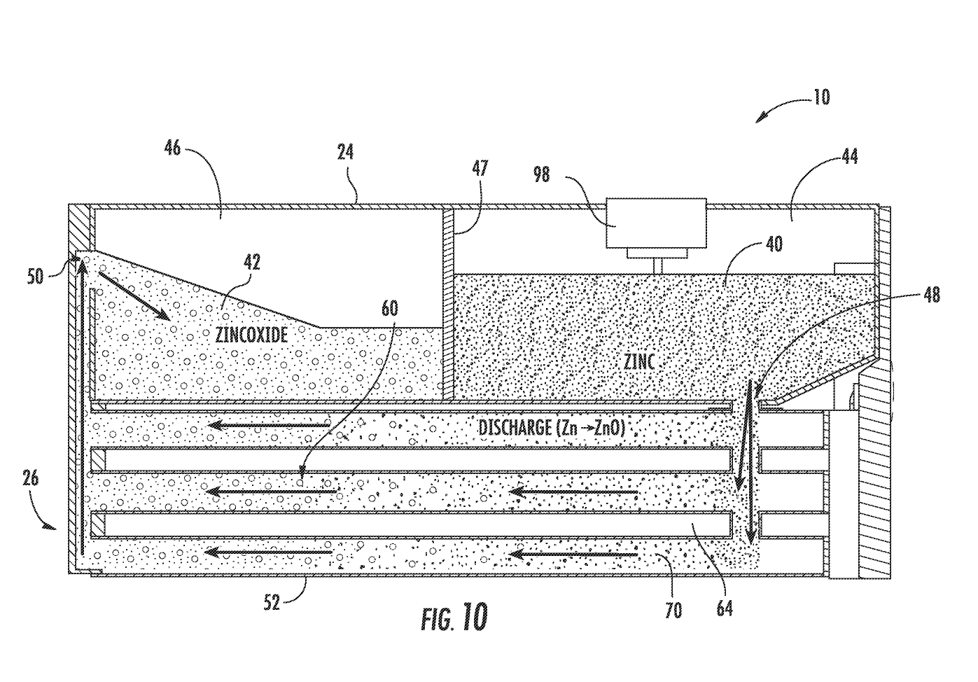

Referring to FIGS. 10-11, operation of zinc-air flow battery 10 during discharge will be discussed according to an exemplary embodiment.

During discharge, the zinc paste 40 is fed from the first cavity 44 through the zinc inlet/outlet 48 and distributed amongst the reaction tubes 52. The screws 90 rotate in a first direction, transporting the zinc paste 40 from proximate the first end portion 66 toward the second end portion 68 of each reaction tube 52. The air flow 80 is directed by the fans 62 through the air flow channels 64 and is at least partially received in the reaction tubes 52 through the openings 122 in the protective casing 114, flowing toward the passage 70, as shown by the air flow paths 82. Oxygen from the air flow 80 is converted to hydroxyl ions in the air electrode 28; this reaction generally involves a reduction of oxygen and consumption of electrons to produce the hydroxyl ions. The hydroxyl ions then migrate toward the zinc electrode 20 in the zinc paste 40 within the passages 70 of the reaction tubes 52. The hydroxyl ions cause the zinc to oxidize, liberating electrons and providing power.

As a result of its interaction with the hydroxyl ions, the zinc paste 40 is converted to the zinc oxide paste 42 within the reaction tubes 52 and releases electrons (see, e.g., FIG. 10 illustrating this conversion). As the screws 90 continue to rotate in the first direction, the zinc oxide paste 42 continues to be transported toward the second wall 58. The zinc oxide paste 42 is eventually transported from reaction tubes 52 through the zinc oxide inlet/outlet 50 and deposited in the second cavity 46 of the tank 24.

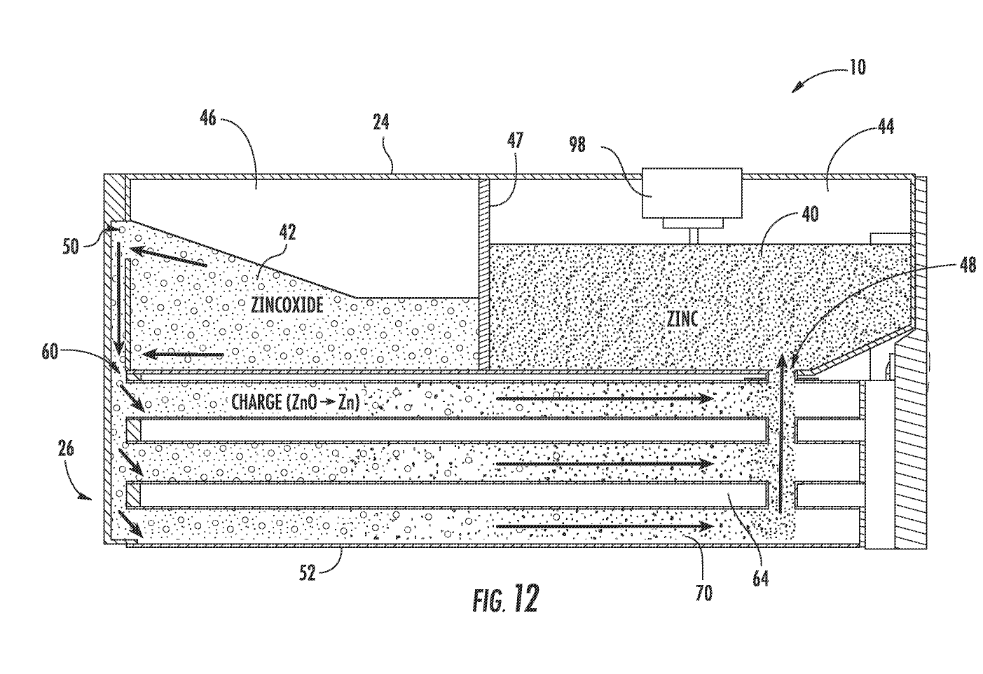

Referring to FIGS. 12-13, operation of zinc-air flow battery 10 during charging will be discussed according to an exemplary embodiment.

As discussed above, the zinc-air flow battery 10 is rechargeable. This is made possible by the development of metal-air electrodes that are electrically rechargeable. During charging, the zinc oxide paste 42 is converted or regenerated back to zinc paste 40. The zinc oxide paste 42 is fed from the second cavity 46 and distributed amongst the reaction tubes 52 by the feed system 60. The screws 90 rotate in the second direction (i.e., opposite to the direction they rotate during discharging), transporting the zinc oxide paste 42 from proximate the second end portion 68 toward the first end portion 66 of each reaction tube 52. The zinc oxide paste 42 is reduced to form the zinc paste 40 as electrons are consumed and stored. Hydroxyl ions are converted to oxygen in the air electrodes 28, adding oxygen to the air flow 80. This oxygen flows from the reaction tubes 52 through the openings 122 in the protective casing 114 outward from proximate the passage 70, as shown by the air flow paths 82.

Referring generally to the FIGS. 2-13, the zinc-air flow battery 10 is includes the control system 98 according to an exemplary embodiment. The control system 98 provides at least two primary functions. First, the control system 98 controls the mechanics of the zinc-air flow battery 10. Second, the control system 98 controls the electronic of the zinc-air flow battery 10.

The mechanical elements of the zinc-air flow battery 10 controlled by the control system 98 include the air flow system (including the fans 62), the feed system 60 (e.g., the screws, the feed mechanism directing the paste 40, 42 from the tank 24 into and out of the reaction tubes 52), and mixing of the pastes 40, 42 within the tank 24 according to an exemplary embodiment. For example, the control system 98 may adjust the rate of the air flow or the rate at which the screws rotate, thereby adjusting the reaction rate.

The electronic aspects/elements of the zinc-air flow battery 10 controlled by the control system 98 include charge/discharge control of current and voltage, cell balancing for multi-tube systems, overcharge and over-discharge controls, and monitoring the state of charge and lifetime of the Zn slurry in the tank. For example, zinc-air flow battery 10 can be discharged and charged “as needed”. In one exemplary embodiment, the flow battery may be activated in response to a signal or other trigger (e.g., a sensor) to discharge energy stored therein or to be recharged to supplement the energy stored therein. The discharge and charge is done by regulating the voltage in the control system. For each single tube in the system, lowering the voltage below the open circuit potential will discharge the battery, while increasing the voltage above the open circuit voltage will charge the battery. In some exemplary embodiments, the control system 98 is configured to integrate the zinc-air flow battery 10 with a given system and/or device that utilizes a constant voltage power profile. In these embodiments, the zinc-air flow battery 10 delivers a substantially constant voltage. In other embodiments, control system 98 of the zinc-air flow battery 10 may be integrated in a system having an unstable voltage profile (e.g., a system and/or device with a pulsing voltage). In these embodiments, the zinc-air flow battery 10 may deliver a varying voltage and/or be further integrated with a secondary battery pack or a super capacitor to handle pulse performance.

One or more sensors (e.g., sensor 126) may be included in or utilized with the control system 98 to provide for these controls and/or the monitoring associated therewith. For example, the sensing device 126 is configured to provide a signal in response to the power requirements of the system and/or device with which zinc-air flow battery 10 is integrated, and thereby help control the rate of discharge and/or charge of the zinc-air flow battery 10. Other sensing devices may be configured to monitor any number of parameters, electrolyte (e.g., KOH) concentration, air pressure, temperature, and/or humidity level and to provide a signal or other response corresponding to data measurements. For example, the sensor may be a pH meter that determines the hydroxide concentration of the electrolyte in the tank, thereby providing an indication of the remaining operational lifetime of the zinc-air flow battery. Still other sensing devices may provide a level indicator to determine the state of charge and discharge. According to some exemplary embodiments, more than one of these functions or other monitoring/sensing functions may be provided by these or other sensors.

For some operations, the mechanical controls interact with the electronic controls according to an exemplary embodiment. For example, when going from discharge into an extended idle or shut down, the mechanical controls will may assure that the zinc paste is pumped into the tank for safe storage and that the valves connecting the tank to the reactions tubes are closed. Also, the fans may be stopped and inlet valves for the intake of air closed for environmental protection of the reaction tubes. When going from a low power to a high power condition, the air flow may be increased to give sufficient oxygen for the reaction and the rotational speed for screws of the feed system is increased to make sure that the discharge level of zinc trough the reaction tubes is constant.

The zinc-air flow battery 10 is modular and allows for customization for use with numerous applications according to an exemplary embodiment. As discussed above, the amount of energy stored (and power that can be provided) by the zinc-air flow battery 10 is related to the volume of tank 24 and the electrochemical capacity of the pastes 40, 42. Accordingly, the electrochemical capacity of the pastes and the tank size and/or number can be tailored to a desired application. Further, the rate of charge or discharge can be adjusted by increasing or decreasing the number of reaction tubes 52. Further still, multiple zinc-air flow batteries may be interconnected and used in combination to satisfy a set of power and energy storage parameters.

Referring to FIG. 14, an another exemplary embodiment of a metal-air flow battery, shown as zinc-air flow battery 210 is shown.

Similar to zinc-air flow battery 10, the zinc-air flow battery 210 is shown as a closed loop system including a zinc electrode 220, an electrolyte 222, one or more storage devices shown as a tank or chamber 224, a reactor 226 having one or more air electrodes 228, and a power input/output device 230.

Also similar to zinc-air flow battery 10, the zinc electrode 220 and the electrolyte 222 (e.g., potassium hydroxide “KOH” or other Off sources) of the zinc-air flow battery 210 are combined (e.g., mixed, stirred, etc.) to form a zinc paste 240, which serves as a reactant for the zinc-air flow battery 210 according to an exemplary embodiment. The reactant (e.g., active material, etc.) is configured to be transported (e.g., fed, pumped, pushed, forced, etc.) into and out of the reactor 226. When the zinc-air flow battery 10 is discharging, the zinc paste 240 is transported into the reactor 226 and a zinc oxide paste 242 is transported out of the reactor 226 after the zinc paste 240 reacts with the hydroxyl ions produced when the air electrode 228 reacts with oxygen from the air. When the zinc-air flow battery 10 is charging, the zinc oxide paste 242 is transported into the reactor 226 and the zinc paste 240 is transported out of the reactor 226 after the hydroxyl ions are converted back to oxygen. According to other exemplary embodiments, the zinc electrode and the electrolyte may be combined in the form of a slurry, a pellet, or other form known in the art.

In contrast zinc-air flow battery 10, the tank 224 includes only a single cavity 244 (e.g., chamber, etc.) in which both the zinc paste 240 and the zinc oxide paste 242 are stored according to an exemplary embodiment. The pastes 240, 242 exit an outlet 248 of tank and enter an inlet 250, generally opposite the outlet 248.

A feed system 260 is provided to transport the pastes 240, 242 through a plurality of reaction tubes 252 of the reactor 226 according to an exemplary embodiment. During operation, a plurality of screws (similar to screws 90) of the feed system 260 transport of move the pastes from a first end portion 266 of each reaction tube 252 toward a second end portion 268 of each reaction tube 252. While the components of feed system 260 is substantially similar to the components of feed system 60, the pastes 240, 242 of zinc-air flow battery 210 are fed in the same direction (i.e., from a first end portion 266 of each reaction tube 252 toward a second end portion 268 of each reaction tube 252) during both charge and discharge. That is, the feed system 260 operates in a substantially unidirectional manner.

Referring further to FIG. 14, operation of zinc-air flow battery 10 during discharge and charge will be discussed according to an exemplary embodiment.

During discharge, the zinc paste 240 is fed from the cavity 244 through the outlet 248 and distributed amongst the reaction tubes 252. The screws rotate in a first direction, transporting the zinc paste 240 from proximate the first end portion 266 toward the second end portion 268 of each reaction tube 252. An air flow 280 is directed by a plurality of fans through a plurality of air flow channels 264 defined between the reaction tubes 252. The air flow 280 is at least partially received in the reaction tubes 252 through a plurality of openings in a protective casings 314 of the reaction tubes 252. Oxygen from the air flow 280 is converted to hydroxyl ions in the air electrode 228; this reaction generally involves a reduction of oxygen and consumption of electrons to produce the hydroxyl ions. The hydroxyl ions then migrate toward the zinc electrode 220 in the zinc paste 240 within the passages 270 of the reaction tubes 252. The hydroxyl ions cause the zinc to oxidize, liberating electrons and providing power.

As a result of its interaction with the hydroxyl ions, the zinc paste 240 is converted to the zinc oxide paste 242 within the reaction tubes 252 and releases electrons (see, e.g., FIG. 10 illustrating this conversion). As the screws continue to rotate in the first direction, the zinc oxide paste 242 continues to be transported toward the second wall 58. The zinc oxide paste 242 is eventually transported from reaction tubes 252 through the inlet 250 and deposited in the cavity 244 of the tank 224.

It should be noted that all of the zinc paste 240 may not be converted to zinc oxide paste 242 in a single pass through the reaction tubes 252. As a result, partially converted paste may be deposited back into the cavity 244 after being transported through the reaction tubes 252. It is generally desirable to continue cycling the pastes 240, 242 through the reaction tubes 252 until more of the zinc paste 240 is converted to zinc oxide paste 242. When zinc paste 240 is sufficiently converted to zinc oxide paste 242, a voltage drop will typically occur. This presence of this voltage drop can be monitored with a sensor, similar to those discussed above in reference to zinc-air flow battery 10.

According to this exemplary embodiment, once the voltage drop is sensed, the air flow 280 will be stopped and a charge voltage will be applied (e.g., using and input/output device such as the power input/output device 30, described above). During charging, the zinc oxide paste 242 is converted or regenerated back to zinc paste 240. The zinc oxide paste 242 is fed from the cavity 244 through outlet 248 and distributed amongst the reaction tubes 252 by the feed system 260 during charging. The screws continue rotating in the first direction (i.e., the same direction they rotate during discharging), transporting the zinc oxide paste 242 from proximate the first end portion 266 toward the second end portion 268 of each reaction tube 252. The zinc oxide paste 242 is reduced to form the zinc paste 240 as electrons are consumed and stored. Hydroxyl ions are converted to oxygen in the air electrodes 228, adding oxygen to the air flow 280. This oxygen flows from the reaction tubes 252 through openings in the protective casing 314, outward from proximate the passages 270.

Similar to the conversion of the zinc paste 240 to the zinc oxide paste 242, the zinc oxide paste 242 may not all be converted to zinc paste in a single pass though the reaction tubes 252. As a result, partially converted paste may be deposited back into the cavity 244 after being transported through the reaction tubes 252. It is generally desirable to continue cycling the pastes 240, 242 through the reaction tubes 252 until more of the zinc oxide paste 242 is converted to zinc paste 240.

Other exemplary reaction tubes that can be used with zinc-air flow battery 10, zinc-air flow battery 210, and any variations thereof will now be discussed.

Referring to FIG. 15, an alternative embodiment of a reaction tube is shown as reaction tube 410. The reaction tube 410 includes an air electrode 412 disposed between at least two protective layers, shown as a base 414 and protective casing 416.

Unlike the air electrodes 28 and 228, the air electrode 412 is shown having two separate portions or layers, each layer being optimized for one of the oxygen evolution reaction and the oxygen reduction reaction. That is, both the oxygen evolution reaction and the oxygen reduction reaction do not take place in a substantially unitary air electrode. Rather, these reactions are split; one reaction taking place in a first portion of the air electrode, shown as the oxygen reduction layer 420, and the other taking place in a second portion of the air electrode 412, shown as the oxygen evolution layer 422.

The reaction tube 410 further includes a first separator 424, a second separator 426, and a central passage 428 configured to transport a paste including a zinc electrode and an electrolyte according to an exemplary embodiment. Similar to separator 112, the first separator 424 is configured to prevent the short circuiting of a reactor. The first separator 424 is shown positioned between the air electrode 412 and the zinc electrode, and is made of plastic. The second separator 426 is shown disposed between the oxygen reduction layer 420 and the oxygen evolution layer 422 of the air electrode 412, helping provide for the separate functionalities of these layers.

The oxygen reduction layer 420 is shown exterior to the oxygen evolution layer 422 according to an exemplary embodiment. As shown in FIG. 15, the oxygen reduction layer 420 is disposed between the protective casing 416 and the second separator 426. In this position, oxygen entering the reaction tube 410 through a plurality of openings 436 in the protective casing 416 can more readily access the oxygen reduction layer 420, facilitating conversion of the oxygen to hydroxyl ions.

The oxygen evolution layer is shown exterior to the first separator 424, but interior to the second separator 426 according to an exemplary embodiment. In this position, the oxygen evolution layer may more readily intercept hydroxyl ions leaving the metal anode during charging, facilitating the oxygen evolution reaction.

It should be noted that feed system 60 or a feed system similar thereto may be used with the reaction tube 410; though, according to other exemplary embodiments, other feed systems suitable for moving or transporting paste through reaction tube 410 may be used. It should also be noted that nucleated gases may be removed from the reaction tube 410 in a manner that is substantially similar to the manner in which they are removed from reaction tube 52.

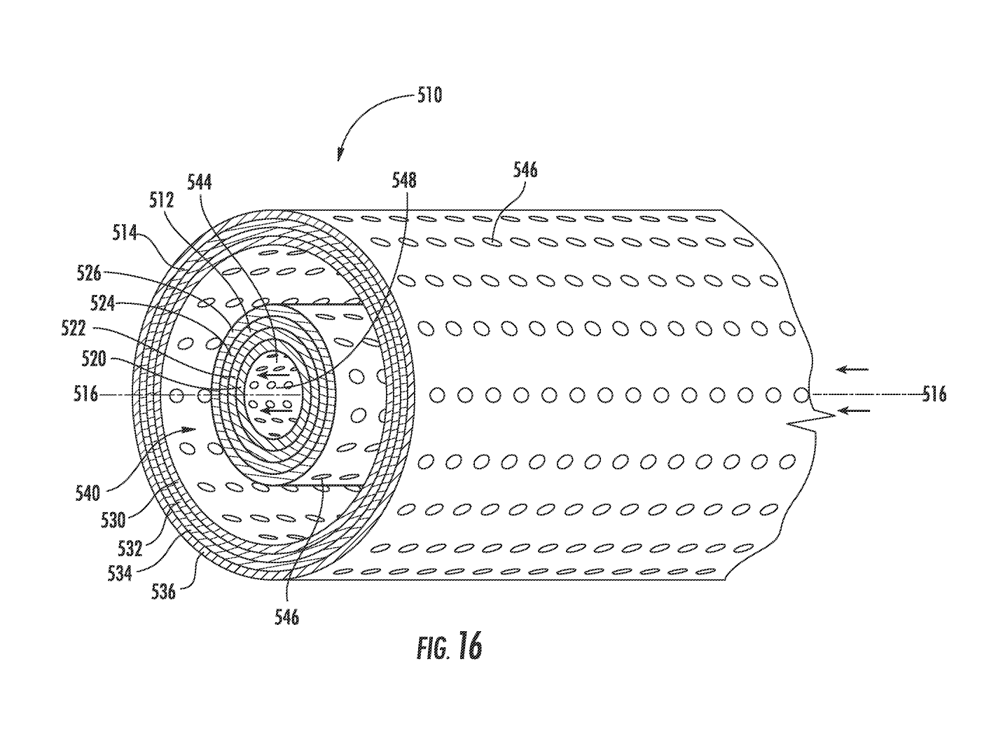

Referring to FIG. 16, an alternative embodiment of a reaction tube is shown as reaction tube 510.

The reaction tube 510 includes an inner tube 512 and an outer tube 514 according to an exemplary embodiment. The inner tube 512 is shown having a layered structure including four layers; moving outward from a longitudinal axis 516 of the reaction tube 510, these layers are a protective casing 520, an air electrode 522, a separator 524, and a base 526. Similarly, the outer tube 514 is shown having a layered structure including four layers; moving away from the longitudinal axis 516, these layers are a base 530, a separator 532, an air electrode 534, and a protective casing 536. Stated otherwise, moving away from the longitudinal axis 516, the layers of the outer tube 514 are the mirror image for the layers of the inner tube 512.

The inner tube 512 is substantially concentric with and spaced a distance from the outer tube 514, defining an annular passage 540 therebetween according to an exemplary embodiment. The annular passage 540 (e.g., channel, conduit, etc.) is configured to receive an anode paste material (e.g., a zinc paste and/or a zinc oxide paste). Similar to the reaction tube 52, the paste is intended to contact the bases 526, 530 of the inner tube 512 and the outer tube 514 as it moves through the annular passage 540. It should be noted that the paste is intended to be fed or moved through the annular passage 540 by a feed system other than feed system 60. For example, a pump-type feed system may be utilized with reaction tube 510.

Also similar to the reaction tube 52, an air flow 544 is intended to be directed along the reaction tube 510 such that oxygen enters through a plurality of openings 546 in the protective casings 520, 536. In the exemplary embodiment shown, this means that air is directed through an central passage 548 defined by the inner tube 512 and along the exterior surface of the outer tube 514.

This configuration provides a number of benefits, including, but not limited to, allowing for a higher power output to be provided because of the increased surface area of the air electrodes 522, 534. It should be noted that, according to other exemplary embodiments, other suitable layering schemes for the inner tube and the outer tube may be used. Though, it is generally desirable for the layering schemes to provide a relatively large air electrode surface area. In this way, the air electrodes may help provide for a relatively high rate capability/power density.

Some additional applications of a metal-air flow battery will now be discussed.

Metal air flow batteries can provide energy storage and conversion solutions for peak shaving, load leveling, and backup power supply (e.g., for renewable energy sources such as wind, solar, and wave energy). The flow batteries may allow for the reduction of energy generation related emissions (e.g., greenhouse gases), and may also be used in a manner intended to improve the efficiency of the public utility sector.

FIG. 17 illustrates an exemplary embodiment of a metal-air flow battery 610 utilized in a smart grid system 600. The metal-air flow battery 610 is shown coupled to a grid 612 via a DC/AC connection 614 and coupled to the renewable energy source 616 via an AC/DC connection 618. The metal-air flow battery 610 provides for metal storage in a first cavity 620 or metal storage cavity, and provides for metal oxide storage in a second cavity 622 or metal oxide cavity.

The metal-air flow battery 610 is configured to store energy generated by the renewable energy source 616 (e.g., windmills, solar panels, etc.). The energy generated by the renewable energy source 616 is stored in the metal-air flow battery 610 in the form of metal paste disposed within the first cavity 620. The metal-air flow battery 610 is further configured to discharge the stored energy to provide power in response a signal or other trigger sent to the metal-air flow battery 610 indicating a need for power. To generate the desired power, the metal paste stored in the first cavity 620 is converted to metal oxide paste. The power generated travels through the DC/AC connection 614 to the grid 612. In this way, the power stored within the metal air flow battery 610 provides or helps to provide the desired amount of electrical power. The ability of the metal-air flow battery 610 to be responsive to and to fill gaps in power needs is particularly helpful for peak shaving (e.g., by providing for load levelling, acting backup power supply, etc.). Thus, the metal-air flow battery 610 can help alleviate problems associated with the intermittent power generation profiles associated with renewable energy sources. Once the metal-air flow battery 610 has been at least partially discharged, it can be charged by the energy received from the renewable energy source 616 and then again discharged to meet power needs. When being charged, power enters AC/DC connection 618 and metal oxide paste is converted back into metal paste.

As will be appreciated by those reviewing the present disclosure, numerous advantages may be obtained using the exemplary embodiments shown herein. For example, because zinc-air flow battery 10 is a rechargeable closed loop system, it is able to be cycled numerous times, providing for longer use and providing a greater quantity of power. This is all done with minimal environmental impact. Other benefits include increased voltage during discharged, increased number of possible cycles, etc.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure.

It is important to note that the construction and arrangement of the metal-air flow battery as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present inventions.

What is claimed is:

1. A metal-air flow battery comprising:
a tank configured to contain an anode paste material;
a reaction tube in fluid communication with the tank, the reaction tube comprising an air electrode, an outer surface configured to allow air to enter the reaction tube, and an internal passage; and
a mechanism for moving the anode paste material through the internal passage of the reaction tube.

2. The metal-air flow battery of claim 1, wherein the mechanism for moving the anode paste material through the internal passage of the reaction tube comprises a screw device.

3. The metal-air flow battery of claim 1, wherein the screw device comprises a fixed rod, a rotatable tube that is rotatably coupled to the fixed rod, and a threaded portion extending from an outer surface of the tube.

4. The metal-air flow battery of claim 3, wherein at least a portion of the threaded portion has a polymeric coating thereon or are formed from a polymeric material.

5. The metal-air flow battery of claim 3, wherein the rotatable tube and the fixed rod are each formed of a conductive material and are electrically coupled together, wherein the fixed rod is configured to act as a first current collector.

6. The metal-air flow battery of claim 5, wherein the rotatable tube and the fixed rod are electrically coupled together by electrically conductive bearings, brushes, or metal particles provided between the rotatable tube and the fixed rod.

7. The metal-air flow battery of claim 5, wherein rotatable tube is configured for electrical contact with the anode paste material as the anode paste material is moved through the internal passage of the reaction tube such that electrical charge may be transmitted between the paste and the fixed rod by way of the rotatable tube.

8. The metal-air flow battery of claim 5, wherein the outer surface of the reaction tube is formed of a conductive material and is configured to act as a second current collector.

9. The metal-air flow battery of claim 1, further comprising a motor coupled to the mechanism for moving the anode paste material to drive the mechanism.

10. The metal-air flow battery of claim 1, further comprising a device for directing a flow of air adjacent the outer surface of the reaction tube, wherein the outer surface of the reaction tube includes a plurality of holes to allow the air to enter the reaction tube to react with the anode paste material being moved through the internal passage of the reaction tube.

11. The metal-air flow battery of claim 1, wherein the anode paste material comprises a metal and the reaction tubes are configured to allow the conversion of the metal to a metal oxide to generate electricity.

12. The metal-air flow battery of claim 11, wherein the metal is selected from the group consisting of zinc, lithium, magnesium, and aluminum.

13. The metal-air flow battery of claim 1, wherein the air electrode is a bifunctional air electrode.

14. The metal-air flow battery of claim 1, wherein the inner passage is defined by an inner tube of the reaction tube, and further comprising a separator disposed between the air electrode and the inner tube.

15. The metal-air flow battery of claim 1, wherein the tank comprises a first chamber and a second chamber, wherein the metal-air battery is configured to move the anode paste material from the first chamber to the second chamber during discharging of the metal-air flow battery and to move the anode paste material from the second chamber to the first chamber during charging of the metal-air flow battery.

16. The metal-air flow battery of claim 1, wherein the tank comprises a single chamber for containing the anode paste material and the metal-air flow battery is configured to move the anode paste material in a single direction through the reaction tube during both charging and discharging of the metal-air flow battery.

17. The metal-air flow battery of claim 1, wherein the metal-air flow battery comprises a plurality of reaction tubes in fluid communication with the tank.

18. A metal-air flow battery comprising:
a tank configured to contain an anode paste material that comprises a metal and an electrolyte;
a plurality of reaction tubes in fluid communication with the tank, the reaction tubes each comprising an air electrode, an outer surface configured to allow air to enter the reaction tube, and an internal passage through which the anode paste material may be directed; and
a plurality of screws driven by a motor, each of the plurality of screws extending through an internal passage of an associated one of the reaction tubes, wherein the screws are configured to move the anode paste material through the reaction tubes.

19. The metal-air flow battery of claim 18, wherein the metal-air flow battery is configured to reversibly convert the anode paste material between a metal paste material and a metal oxide paste material such that the metal-air flow battery is a rechargeable metal-air flow battery.

20. The metal-air flow battery of claim 18, wherein each of the plurality of screws comprises a fixed rod, a rotatable tube that is rotatably and electrically coupled to the fixed rod, and a threaded portion extending from an outer surface of the tube.

21. The metal-air flow battery of claim 20, wherein at least a portion of the threaded portion has a polymeric coating thereon or are formed from a polymeric material.

22. The metal-air flow battery of claim 20, wherein the rotatable tube is configured to make electrical contact with the anode paste material being moved by the screw and is also electrically coupled to the fixed rod.

23. The metal-air flow battery of claim 22, wherein the rotatable tube and the fixed rod are electrically coupled together by electrically conductive bearings, brushes, or metal particles provided between the rotatable tube and the fixed rod.

24. The metal-air flow battery of claim 18, wherein the outer surface of each of the reaction tubes is formed of a conductive material and is configured to act as a current collector.

25. The metal-air flow battery of claim 18, wherein the motor is coupled to the plurality of screws by a belt.

26. The metal-air flow battery of claim 18, further comprising at least one fan for directing a flow of air adjacent the outer surfaces of the reaction tubes, wherein the outer surfaces of the reaction tubes include holes to allow the air to enter the reaction tubes to react with the anode paste material being moved through the internal passages of the reaction tubes.

27. The metal-air flow battery of claim 18, wherein the anode paste material comprises zinc.

28. The metal-air flow battery of claim 18, wherein each of the reaction tubes further comprises a separator to provide electrical isolation between the anode paste material and the air electrode.

29. The metal-air flow battery of claim 18, wherein the tank comprises a first chamber and a second chamber, wherein the metal-air flow battery is configured to move the anode paste material from the first chamber to the second chamber during discharging of the metal-air flow battery and to move the anode paste material from the second chamber to the first chamber during charging of the metal-air flow battery.

30. The metal-air flow battery of claim 18, wherein the tank comprises a single chamber for containing the anode paste material and the metal-air flow battery is configured to move the anode paste material in a single direction through the reaction tubes during both charging and discharging of the metal-air flow battery.

31. A metal-air flow battery comprising:
a storage tank configured to contain an anode paste;
a plurality of reaction tubes coupled to the storage tank, the reaction tubes each comprising an air electrode, wherein the metal-air flow battery is configured to move the anode paste through the reaction tubes during charging and discharging to reversibly convert the anode paste between a metal anode paste and a metal-oxide anode paste.

32. The metal-air flow battery of claim 31, wherein the metal-air flow battery further comprises a plurality of motor-driven elements for moving the anode paste through the reaction tubes.

33. The metal-air flow battery of claim 32, wherein the motor-driven elements are configured to move the anode paste in a first direction through the reaction tubes during discharging and in a second opposite direction during charging.

34. The metal-air flow battery of claim 32, wherein the motor-driven elements are screws, and wherein at least a portion of each of the screws is configured to be in electrical contact with the anode paste.

35. The metal-air flow battery of claim 34, wherein at least a portion of each of the screws has a polymeric coating provided thereon.

36. The metal-air flow battery of claim 31, further comprising a controller for controlling operation of the metal-air flow battery.

37. The metal-air flow battery of claim 31, wherein each of the reaction tubes comprises a conductive outer surface having holes provided therein to allow air to enter the reaction tube, a separator, and an inner tube defining a central passage through which the anode paste material may flow.

38. The metal-air flow battery of claim 31, wherein the air electrode comprises a gas diffusion layer and an active layer.

39. The metal-air flow battery of claim 31, further comprising a mixing device configured to stir the anode paste material in the storage tank.
